(19) United States
(12) Patent Application Publication
(10) Pub. No.: US 2024/0348310 A1
(43) Pub. Date: Oct. 17, 2024

(54) CONFIGURATION INDICATION FOR BEAM RESTRICTION IN INTEGRATED ACCESS AND BACKHAUL (IAB) NODES

(71) Applicant: Telefonaktiebolaget LM Ericsson (publ), Stockholm (SE)

(72) Inventors: Andreas NILSSON, Göteborg (SE); Magnus ÅSTRÖM, Lund (SE); Boris DORTSCHY, Vendelsö (SE); Lei BAO, Göteborg (SE)

(21) Appl. No.: 18/580,333

(22) PCT Filed: Jul. 22, 2022
(86) PCT No.: PCT/EP2022/070669

§ 371 Date: Jan. 18, 2024

Related U.S. Application Data
(60) Provisional application No. 63/225,150, filed on Jul. 23, 2021.

(51) Int. Cl. H04B 7/06; H04B 7/155

(52) U.S. Cl. CPC H04B 7/0695; H04B 7/0697; H04B 7/1555

(57) ABSTRACT

A method, system and apparatus are provided. In one embodiment, an IAB node is provided. The IAB node includes processing circuitry configured to determine at least one restricted beam for an IAB-distributed unit, IAB-DU, of a child IAB node when operating in spatial division multiplexing, SDM, and indicate the at least one restricted beam for configuring the child IAB node where the indication of the at least one restricted beam corresponds to a deactivation of a Transmission Configuration Indicator, TCI state, which would be available when operating in time division multiplexing, TDM.

### TECHNICAL FIELD

The present disclosure relates to wireless communications, and in particular, to configuring beam restriction for integrated access and backhaul (IAB) nodes.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (wireless device), as well as communication between network nodes and between wireless devices. Sixth Generation (6G) wireless communication systems are also under development.

Wireless communication systems according to the 3GPP may include the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

Densification via the deployment of increasing numbers of base stations/network nodes (including macro or micro base stations) can be employed to help satisfy the ever-increasing demand for more and more bandwidth/capacity in mobile networks. Due to the availability of more spectrum in the millimeter wave (mmw) band, deploying small cells that operate in this band is one deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

FIG. 1 shows an example of an IAB deployment that supports multiple hops. The IAB-donor has a wired connection to the core network and the IAB nodes are wirelessly connected using NR to the IAB-donor, either directly or indirectly via another IAB node. The connection between IAB-donor/node and wireless devices is referred to as an access link, whereas the connection between two IAB nodes or between an IAB-donor and an IAB node is called a backhaul link, e.g., wireless backhaul link.

Furthermore, as shown in FIG. 2, the adjacent upstream IAB node which is closer to the IAB-donor of an IAB node may be referred to as a parent node of the IAB-node. The adjacent downstream node which is further away from the IAB-donor of an IAB node may be referred to as a child node of the IAB-node. The backhaul link between the parent node and the IAB node may be referred to as the parent (backhaul) link, whereas the backhaul link between the IAB node and the child node may be referred to as the child (backhaul) link.

One major difference of the IAB architecture compared to an 3GPP Technical Release 10 (Rel-10) LTE relay (besides lower layer differences) is that the IAB architecture adopts the Central-Unit/Distributed-Unit (CU/DU) split of NR network nodes (e.g., base stations, gNBs). Thus, in the IAB architecture, time-critical functionalities are realized in the IAB-DU closer to the radio, whereas the less time-critical functionalities are pooled in the CU with the opportunity for centralization. Based on this architecture, an IAB-donor contains both CU and DU functions. In particular, it contains all CU functions of the IAB nodes under the same IAB-donor. Each IAB node then hosts the DU function(s) of a network node. In order to be able to transmit and receive wireless signals to and from the upstream IAB node or IAB-donor, each IAB node has a mobile termination (MT). An MT is a logical unit providing a necessary set of wireless device-like functions. Via the IAB-DU, the IAB node establishes radio link control channels (RLC-channels) to wireless devices and/or to MTs of the connected IAB-node(s). Via the IAB-MT, the IAB node establishes the backhaul radio interface towards the serving IAB node or IAB-donor. FIG. 3 shows a reference diagram for a two-hop chain of IAB nodes under an IAB-donor.

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB nodes. Also, traffic variations can create uneven load distribution on wireless backhaul links leading to local link or node congestion. In view of those concerns, the IAB topology supports redundant paths as another difference compared to the 3GPP Rel-10 LTE relay.

The following topologies are considered in IAB as shown in FIG. 4:
Spanning tree (ST); and
Directed acyclic graph (DAG).

The graphs show that one IAB node (e.g., IAB-1, IAB-6, etc.) can have multiple child nodes and/or have multiple parent nodes. Particularly regarding multi-parent topology, different scenarios may be considered as shown in FIG. 5. For example:
IAB-9 connects to IAB-donor 1 via two parent nodes IAB-5 and IAB-6 which connect to the same grandparent node IAB-1;
IAB-10 connects to IAB-donor 1 via two parent nodes IAB-6 and IAB-7 which connect to different grandparent nodes IAB-1 and IAB-2; and
IAB-8 connects to two parent nodes IAB-3 and IAB-4 which connect to different IAB-donors IAB-donor 1 and IAB-donor 2.

The multi-connectivity or route redundancy may be used for back-up purposes. It is also possible that redundant routes are used concurrently, e.g., to achieve load balancing, reliability, etc.

According to the 3GPP IAB Technical Release (TR) 38.874, when operating in SA-mode, an NR+NR dual connected IAB node can add redundant routes by establishing an MCG-link (master cell group) to one parent node IAB-DU and an SCG-link (secondary cell group) to another parent node IAB-DU. The dual-connecting IAB-MT will enable the SCG link using the 3GPP Rel-15 NR-DC procedures.

### Resource Coordination

In case of in-band operation, the IAB node is typically subject to the half-duplex constraint, i.e., an IAB node can only be in either transmission or reception mode at a time. The 3GPP Rel-16 IAB specification mainly considers the time-division multiplexing (TDM) case where the IAB-MT and IAB-DU resources of the same IAB node are separated in time. Based on this consideration, the following resource types have been defined for IAB-MT and IAB-DU, respectively.

From an IAB-MT point-of-view, as in 3GPP Rel-15, the following time-domain resources can be indicated for the parent link:
Downlink (DL) time resource;
Uplink (UL) time resource; and/or
Flexible (F) time resource.

From an IAB node DU point-of-view, the child link has the following types of time resources:
DL time resource;
UL time resource;
F time resource; and/or
C Not-available (NA) time resources (resources not to be used for communication on the DU child links).

Each of the downlink, uplink and flexible time-resource types of the DU child link can belong to one of two categories:
Hard (H): The corresponding time resource is always available for the DU child link; and
Soft(S): The availability of the corresponding time resource for the DU child link is explicitly and/or implicitly controlled by the parent node.

The IAB-DU resources are configured per cell, and the hard/soft/not available (H/S/NA) attributes for the IAB-DU resource configuration are explicitly indicated per-resource type (downlink/uplink/flexible) (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relationships between IAB-MT and IAB-DU resources are listed in Table I.

TABLE 1
Coordination between IAB-MT and IAB-DU resources of an IAB-node.

| | | IAB-MT configuration | | |
|---|---|---|---|---|
| | | DL | UL | Flexible |
| DU | DL-H | DU: can transmit on DL unconditionally; | DU: can transmit on DL unconditionally; | DU: can transmit on DL unconditionally; |
| configuration | | MT: not available. | MT: not available. | MT: not available. |
| | DL-S | DU: can transmit conditionally; | DU: can transmit conditionally; | DU: can transmit conditionally; |
| | | MT: available on DL. | MT: available on UL. | MT: available on DL & UL. |
| | UL-H | DU: can schedule UL unconditionally; | DU: can schedule UL unconditionally; | DU: can schedule UL unconditionally; |
| | | MT: not available. | MT: not available. | MT: not available. |
| | UL-S | DU: can schedule UL conditionally; | DU: can schedule UL conditionally; | DU: can schedule UL conditionally; |
| | | MT: available on DL. | MT: available on UL. | MT: available on DL & UL. |
| | F-H | DU: can transmit on DL or schedule UL | DU: can transmit on DL or schedule UL | DU: can transmit on DL or schedule UL |
| | | unconditionally; MT: not available. | unconditionally; MT: not available. | unconditionally; MT: not available. |
| | F-S | DU: can transmit on DL or schedule UL | DU: can transmit on DL or schedule UL | DU: can transmit on DL or schedule UL |
| | | conditionally; MT: available on DL. | conditionally; MT: available on UL. | conditionally; MT: available on DL & UL. |
| | NA | DU: not available; MT: available on | DU: not available; MT: available on | DU: not available; MT: available on |
| | | DL. | UL. | DL & UL. |

In 3GPP Rel-16 IAB there are two ways for the parent IAB nodes to indicate the availability of the soft time-domain DU resource: implicit indication and explicit indication. This is identified in the 3GPP Technical Standard (TS) 38.213 specification, a portion of which is described below.

With reference to slots of an IAB-DU cell, a symbol in a slot of an IAB-DU cell can be configured to be of hard, soft, or unavailable type. When a downlink, uplink, or flexible symbol is configured as hard, the IAB-DU cell can respectively transmit, receive, or either transmit or receive in the symbol. When a downlink, uplink, or flexible symbol is configured as soft, the IAB-DU cell can respectively transmit, receive or either transmit or receive in the symbol only if:
the IAB-MT does not transmit or receive during the symbol of the IAB-DU cell; or
the IAB-MT would transmit or receive during the symbol of the IAB-DU cell, and the transmission or reception during the symbol of the IAB-DU cell is not changed due to a use of the symbol by the IAB-DU; or
the IAB-MT detects a DCI format 2_5 with an AI index field value indicating the soft symbol as available.

The explicit indication, referred to as the Availability Indication (AI) in item c, uses downlink control information (DCI) Format 2_5 for dynamically indicating the availability of IAB-DU soft resources in a slot.

Items a and b above determine availability based on implicit indication, where particularly the second bullet states that the IAB-DU may use a symbol provided it does not change (interfere) with any transmission or reception that the IAB-MT may be part in.

The above description refers to the 3GPP Rel-16 IAB specification.

Further, 3GPP Rel-17 may support enhancements such as spatial division multiplexing (SDM). However, SDM operation within the context of IAB nodes may cause interference due to, for example, the IAB-MT and IAB-DU using the same time- and frequency-domain resource simultaneously. Hence, SDM operation in IAB networks suffers from various issues.

Therefore existing IAB solutions suffer from one or more issues described above.

### SUMMARY

Some embodiments advantageously provide methods, systems, and apparatuses for configuring beam restriction for integrated access and backhaul (IAB) node(s). One or more embodiments provides for transmission configuration indicator (TCI) configurations for IAB spatial domain simultaneous operation.

Some embodiments include methods to facilitate IAB space-domain simultaneous operations by associating the set of restricted beams indicated by the parent IAB node to IAB-DU using TCI. A mechanism is disclosed to associate the set of restricted beams which is indicated by the parent IAB-node.

In one embodiment, the parent IAB node indicates a number of restricted IAB-DU beams by signaling reference signal indexes (i.e., SSB-RI, CRI, SRI, for SSB, CSI-RS and SRS beams, respectively) or TCI IDs to the IAB-node, where each reference signal index or TCI state ID is associated to an IAB-DU beam. The indicated IAB-DU beams may be restricted for use when the IAB node is operating in SDM mode (but can still be used when operating in TDM mode). The indication of restricted beams may be done using L1/L2 signaling.

In another embodiment, the restricted beam set may be reported to the donor-CU. Accordingly, the donor-CU may provide a separate TCI configuration for SDM operation. When operating in the SDM mode, all the TCI states in the SDM-TCI configuration can be activated.

Some embodiments allow an IAB node to operate in the spatial domain, meaning that both the IAB-MT and IAB-DU can operate (transmit and/or receive) using the same time-frequency resources. In doing so, the capacity of the IAB node can be greatly increased, in turn resulting in increased network performance, reduced latency and improved user experience.

According to one aspect of the present disclosure, an Internet Access and Backhaul, IAB, node that is configured to communicate with a child IAB node is provided. The IAB node includes processing circuitry configured to: determine at least one restricted beam for an IAB-distributed unit, IAB-DU, of a child IAB node when operating in spatial division multiplexing, SDM, and indicate the at least one restricted beam for configuring the child IAB node where the indication of the at least one restricted beam corresponds to a deactivation of a Transmission Configuration Indicator, TCI state, which would be available when operating in time division multiplexing, TDM.

According to one or more embodiments of this aspect, the indication is communicated to the child IAB node. According to one or more embodiments of this aspect, the at least one restricted beam is configured to restrict selection to one of: the at least one restricted beam: another beam that is located within the at least one restricted beam, and another beam that partially overlaps with the at least one restricted beam. According to one or more embodiments of this aspect, the indication of the at least one restricted beam is associated with at least one TCI state.

According to one or more embodiments of this aspect, the indication is provided by signaling individually per carrier. According to one or more embodiments of this aspect, the at least one restricted beam corresponds to a plurality of restricted beams to be applied to one of: a single carrier, subset of a plurality of carriers and the plurality of carriers. According to one or more embodiments of this aspect, the at least one restricted beam is indicated by one of: Medium Access Control-Control Element, MAC-CE signaling: at least one SSB index in MAC-CE signaling; and at least one Channel State Information-Reference Signal, CSI-RS, resource index in MAC-CE signaling.

According to one or more embodiments of this aspect, the restriction of the at least one restricted beam is configured to be considered by the child IAB node operating in SDM operation mode; and the restriction of the at least one restricted beam is configured to be disregarded by the child IAB node operating in TDM operation mode. According to one or more embodiments of this aspect, the indication is transmitted to a Donor IAB node. According to one or more embodiments of this aspect, the processing circuitry is further configured to activate one of a TDM operation mode and SDM operation mode at the child IAB node, the at least one restricted beam being associated with the SDM operation mode and not the TDM operation mode.

According to one or more embodiments of this aspect, the at least one restricted beam corresponds to at least one downlink beam used for communication from the child IAB node to a first IAB node. According to one or more embodiments of this aspect, the at least one restricted beam allows the IAB-DU and IAB-Mobile Termination, IAB-MT, of the child IAB node to simultaneously use the same resources. According to another aspect of the present disclosure, an Internet Access and Backhaul, IAB, node, is provided. The IAB node includes processing circuitry configured to: transmit a plurality of synchronization signal blocks, SSBs: receive an indication associated with at least one restricted beam for an IAB-distributed unit, IAB-DU, of the IAB node; and determine at least one IAB-DU beam for downlink transmission based at least on the indication associated with the at least one restricted beam where the indication of the at least one restricted beam is associated with at least one Transmission Configuration Indicator, TCI, state.

According to one or more embodiments of this aspect, the indication is an explicit indication of the at least one restricted beam received from a parent IAB node. According to one or more embodiments of this aspect, the processing circuitry is further configured to, based on the indication, avoid selecting one of: the at least one restricted beam: another beam that is located within the at least one restricted beam; and another beam that partially overlaps with the at least one restricted beam. According to one or more embodiments of this aspect, the indication is provided by signaling individually per carrier.

According to one or more embodiments of this aspect, the at least one restricted beam corresponds to a plurality of restricted beams to be applied to one of: a single carrier, subset of a plurality of carriers and the plurality of carriers. According to one or more embodiments of this aspect, the at least one restricted beam is indicated by one of: Medium Access Control-Control Element, MAC-CE signaling: at least one SSB index in MAC-CE signaling; and at least one Channel State Information-Reference Signal, CSI-RS, resource index in MAC-CE signaling. According to one or more embodiments of this aspect, the processing circuitry is configured to: consider the restriction of the at least one restricted beam based on the IAB node operating in Spatial Division Multiplexing, SDM, operation mode; and disregard the restriction of the at least one restricted beam based on the IAB node operating in Time Division Multiplexing, TDM, operation mode.

According to one or more embodiments of this aspect, the indication is a plurality of TCI configurations associated with the at least one restricted beam, the indication being received from a Donor IAB node. According to one or more embodiments of this aspect, the processing circuitry is further configured to activate one of a Time Division Multiplexing, TDM, operation mode and Spatial Division Multiplexing, SDM, operation mode, the at least one restricted beam being associated with the SDM operation mode and not the TDM operation mode. According to one or more embodiments of this aspect, the at least one restricted beam corresponds to at least one downlink beam used for communication from the IAB node to a child IAB node. According to one or more embodiments of this aspect, the at least one restricted beam allows the IAB-DU and IAB-Mobile Termination, IAB-MT, of the IAB node to simultaneously use the same resources.

According to another aspect of the present disclosure, a method implemented by an Internet Access and Backhaul, IAB, node that is configured to communicate with a child IAB node is provided. At least one restricted beam is determined for an IAB-distributed unit, IAB-DU, of a child IAB node when operating in spatial division multiplexing, SDM. The at least one restricted beam for configuring the child IAB node is indicated where the indication of the at least one restricted beam corresponds to a deactivation of a Transmission Configuration Indicator, TCI state, which would be available when operating in time division multiplexing, TDM.

According to one or more embodiments of this aspect, the indication is communicated to the child IAB node. According to one or more embodiments of this aspect, the at least one restricted beam is configured to restrict selection to one of: the at least one restricted beam: another beam that is located within the at least one restricted beam; and another beam that partially overlaps with the at least one restricted beam. According to one or more embodiments of this aspect, the indication of the at least one restricted beam is associated with at least one TCI state.

According to one or more embodiments of this aspect, the indication is provided by signaling individually per carrier. According to one or more embodiments of this aspect, the at least one restricted beam corresponds to a plurality of restricted beams to be applied to one of: a single carrier, subset of a plurality of carriers and the plurality of carriers. According to one or more embodiments of this aspect, the at least one restricted beam is indicated by one of: Medium Access Control-Control Element, MAC-CE signaling: at least one SSB index in MAC-CE signaling; and at least one Channel State Information-Reference Signal, CSI-RS, resource index in MAC-CE signaling. According to one or more embodiments of this aspect, the restriction of the at least one restricted beam is configured to be considered by the child IAB node operating in SDM operation mode where the restriction of the at least one restricted beam is configured to be disregarded by the child IAB node operating in TDM operation mode.

According to one or more embodiments of this aspect, the indication is transmitted to a Donor IAB node. According to one or more embodiments of this aspect, one of a TDM operation mode and SDM operation mode is activated at the child IAB node where the at least one restricted beam is associated with the SDM operation mode and not the TDM operation mode. According to one or more embodiments of this aspect, the at least one restricted beam corresponds to at least one downlink beam used for communication from the child IAB node to a first IAB node. According to one or more embodiments of this aspect, the at least one restricted beam allows the IAB-DU and IAB-Mobile Termination, IAB-MT, of the child IAB node to simultaneously use the same resources.

According to another aspect of the present disclosure, a method implemented by an Internet Access and Backhaul, IAB, node is provided. A plurality of synchronization signal blocks, SSBs are transmitted. An indication associated with at least one restricted beam for an IAB-distributed unit, IAB-DU, of the IAB node is received. At least one IAB-DU beam for downlink transmission is determined based at least on the indication associated with the at least one restricted beam, the indication of the at least one restricted beam being associated with at least one Transmission Configuration Indicator, TCI, state.

According to one or more embodiments of this aspect, the indication is an explicit indication of the at least one restricted beam received from a parent IAB node. According to one or more embodiments of this aspect, based on the indication, selection is avoided of one of: the at least one restricted beam: another beam that is located within the at least one restricted beam; and another beam that partially overlaps with the at least one restricted beam. According to one or more embodiments of this aspect, the indication is provided by signaling individually per carrier.

According to one or more embodiments of this aspect, the at least one restricted beam corresponds to a plurality of restricted beams to be applied to one of: a single carrier, subset of a plurality of carriers and the plurality of carriers. According to one or more embodiments of this aspect, the at least one restricted beam is indicated by one of: Medium Access Control-Control Element, MAC-CE signaling: at least one SSB index in MAC-CE signaling; and at least one Channel State Information-Reference Signal, CSI-RS, resource index in MAC-CE signaling. According to one or more embodiments of this aspect, the restriction of the at least one restricted beam is considered based on the IAB node operating in Spatial Division Multiplexing, SDM, operation mode, and the restriction of the at least one restricted beam disregarded based on the IAB node operating in Time Division Multiplexing, TDM, operation mode.

According to one or more embodiments of this aspect, the indication is a plurality of TCI configurations associated with the at least one restricted beam, the indication being received from a Donor IAB node. According to one or more embodiments of this aspect, one of a Time Division Multiplexing, TDM, operation mode and Spatial Division Multiplexing, SDM, operation mode is activated where the at least one restricted beam being associated with the SDM operation mode and not the TDM operation mode. According to one or more embodiments of this aspect, the at least one restricted beam corresponds to at least one downlink beam used for communication from the IAB node to a child IAB node. According to one or more embodiments of this aspect, the at least one restricted beam allows the IAB-DU and IAB-Mobile Termination, IAB-MT, of the IAB node to simultaneously use the same resources.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a multi-hop IAB deployment;

FIG. 2 illustrates IAB terminology:

FIG. 3 illustrates an IAB architecture:

FIG. 4 illustrates two IAB topologies:

FIG. 5 illustrates IAB multiparent scenarios:

FIG. 6 illustrates transmission and reception with multiple beams:

FIGS. 7a-c illustrate UL beam management:

FIG. 8 illustrates an example spatial relation information element (IE);

FIG. 9 illustrates another example spatial relation IE;

FIGS. 10a-b illustrate space division multiplexing:

FIG. 11 is a schematic diagram of an example network architecture illustrating a communication system connected via an intermediate network to a host computer according to the principles in the present disclosure:

FIG. 12 is a block diagram of a host computer communicating via a network node with a wireless device over an at least partially wireless connection according to some embodiments of the present disclosure:

FIG. 13 is a flowchart illustrating example methods implemented in a communication system including a host computer, a network node and a wireless device for executing a client application at a wireless device according to some embodiments of the present disclosure:

FIG. 14 is a flowchart illustrating example methods implemented in a communication system including a host computer, a network node and a wireless device for receiving user data at a wireless device according to some embodiments of the present disclosure:

FIG. 15 is a flowchart illustrating example methods implemented in a communication system including a host computer, a network node and a wireless device for receiving user data from the wireless device at a host computer according to some embodiments of the present disclosure:

FIG. 16 is a flowchart illustrating example methods implemented in a communication system including a host computer, a network node and a wireless device for receiving user data at a host computer according to some embodiments of the present disclosure;

FIG. 17 is a flowchart of an example process in a network node for transmission configuration indicator (TCI) configuration for integrated access and backhaul (IAB) spatial domain simultaneous operation:

FIG. 18 is a flowchart of an example process in a network node according to some embodiments of the present disclosure:

FIG. 19 is a flowchart of another example process in a network node according to some embodiments of the present disclosure:

FIG. 20 is a flowchart of another example process in a network node according to some embodiments of the present disclosure:

FIG. 21 is illustrates two IAB nodes:

FIG. 22 illustrates an example of SSB beams;

FIG. 23 illustrates an example of received signal strength of different SSB beams:

FIG. 24 is an example of beams that can be used when certain beams are restricted:

FIG. 25 is a flowchart of an example process embodiment for signaling of restricted beams; and

FIG. 26 is a flowchart of an example process for providing separate TDM-TCI and SDM-TCI configurations.

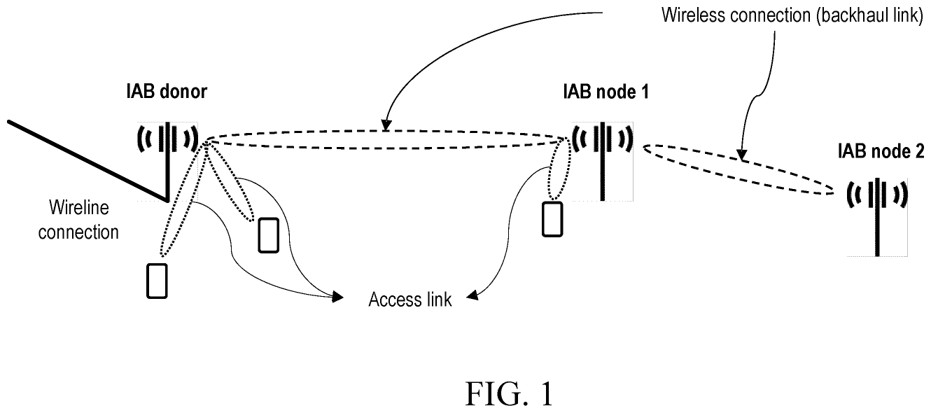

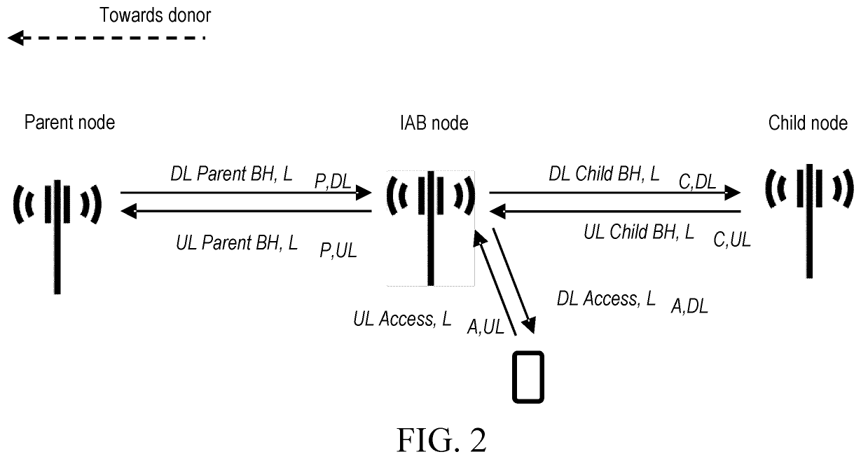

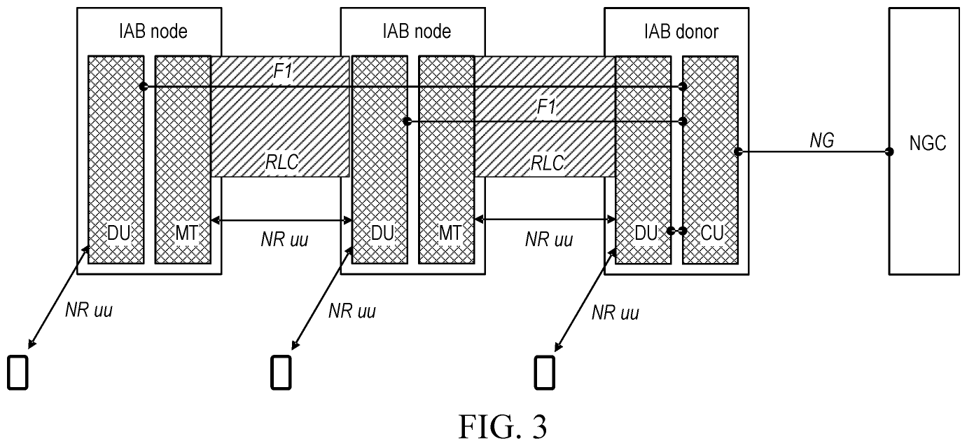

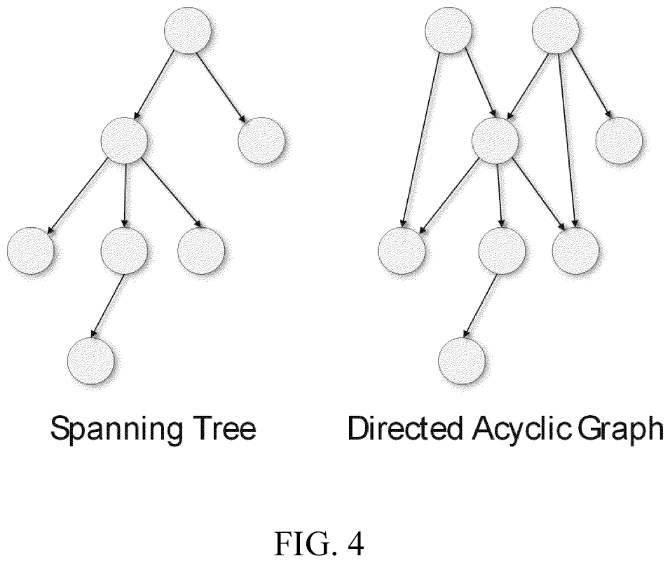

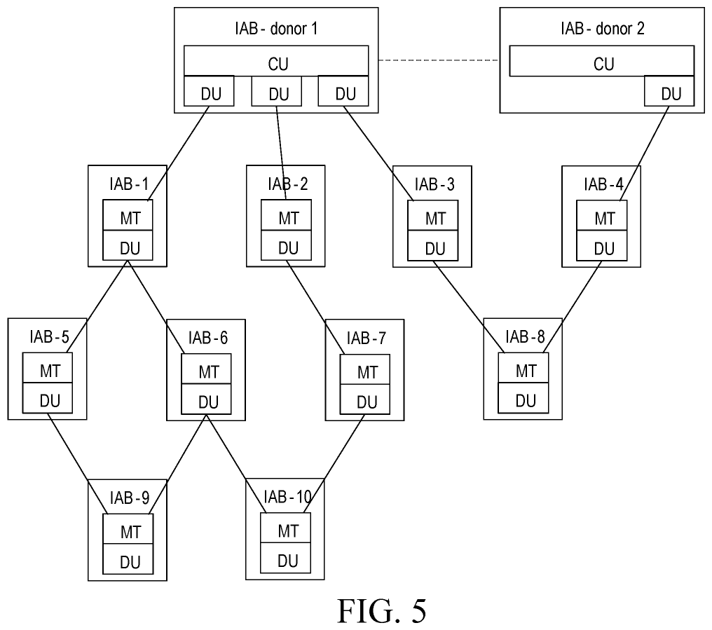

### DETAILED DESCRIPTION

Some enhancements have been generally proposed for IAB networks. In the 3GPP Rel-17 enhanced IAB work item description (WID), the following duplexing enhancements are described:
Specification of enhancements to the resource multiplexing between child and parent links of an IAB node, including:
   i) Support of simultaneous operation (transmission and/or reception) of IAB-node's child and parent links (i.e., MT Tx/DU Tx, MT Tx/DU Rx, MT Rx/DU Tx, MT Rx/DU Rx).

The simultaneous operation includes both frequency-division multiplexing (FDM) and spatial-division multiplexing (SDM).

To facilitate SDM operation, RAN1 considered in meetings RAN1 #104bis-e and RAN1 #105e support of restriction, usage and availability of beams to facilitate simultaneous operations and interference management:
To facilitate simultaneous operations and interference management, dynamic indication for restriction/usage/availability of beams (in upstream and/or downstream directions) is supported.
In case of simultaneous MT/DU operation:
   i) the parent IAB node can dynamically indicate to the child IAB node at least a set of restricted beams at the IAB-DU of the child IAB node; and/or
   ii) the child IAB node can dynamically report to the parent IAB node a set of recommended beams, not-preferred beams, or both recommended and not-preferred beams of the IAB-MT of the child IAB node.

In the high frequency range (FR2), multiple radio frequency (RF) beams may be used to transmit and receive signals at a network node and a wireless device. For each DL beam from a network node, there is typically an associated best wireless device receive (Rx) beam for receiving signals from the DL beam. The DL beam and the associated wireless device Rx beam forms a beam pair. The beam pair can be identified through a beam management process in NR.

A DL beam is (typically) identified by an associated DL reference signal (RS) transmitted in the beam, either periodically, semi-persistently, or aperiodically. The DL RS for the purpose can be a Synchronization Signal (SS) and/or Physical Broadcast Channel (PBCH) block (SSB) or a Channel State Information RS (CSI-RS). For each DL RS, a wireless device can do a Rx beam sweep to determine the best Rx beam associate with the DL beam. The best Rx beam for each DL RS is then memorized/stored by the wireless device. By measuring all the DL RSs, the wireless device can determine and report to the network node the best DL beam to use for DL transmissions.

Assuming the principle of channel reciprocity, the beam pair used for DL transmission can also be used in the UL to transmit a UL signal to the network node, often referred to as beam correspondence.

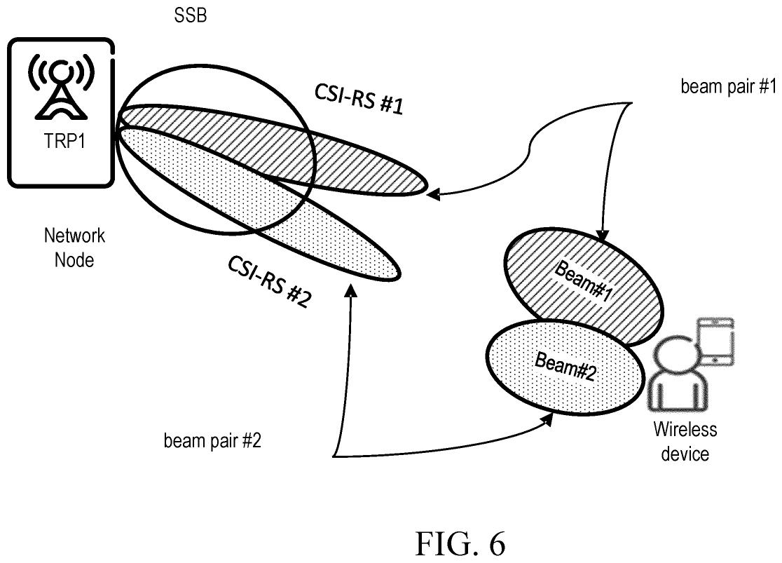

An example is shown in in FIG. 6, where a network node includes a transmission point (TRP) with two DL beams each associated with an individual CSI-RS and a common SSB beam. Each of the DL beams is associated with a best wireless device Rx beam, i.e., wireless device Rx beam #1 is associated with the DL beam with CSI-RS #1 and Rx beam #2 is associated with the DL beam with CSI-RS #2.

Due to wireless device movement or change in environment and/or channel, the best DL beam for a wireless device may change over time and different DL beams may be used at different times. The DL beam used for a DL data transmission in the PDSCH can be indicated by a transmission configuration indicator (TCI) field in the corresponding DCI (Downlink Control Information) scheduling the PDSCH or activating the PDSCH in case of semi-persistent scheduling (SPS). The TCI field indicates a TCI state which contains a DL RS associated with the DL beam. In the DCI, a PUCCH resource is indicated for carrying the corresponding hybrid automatic repeat request (HARQ) acknowledgement/non-acknowledgement (ACK/NACK). The UL beam used for transmission of the PUCCH is determined by a PUCCH spatial relation activated for the PUCCH resource. For PUSCH transmission, the UL beam is indicated indirectly by a sounding reference signal (SRS) resource indicator (SRI), which points to one or more SRS resources associated with the PUSCH transmission. The SRS resource(s) can be periodic, semi-persistent, or aperiodic. Each SRS resource is associated with an SRS spatial relation in which a DL RS (or another SRS) is specified. The UL beam for the PUSCH is implicitly indicated by the SRS spatial relation(s).

### Spatial Relations

Spatial relations are used in NR to refer to a spatial relationship between an UL channel or signal, such as PUCCH, PUSCH and SRS, and a DL (or UL) reference signal (RS), such as CSI-RS (DL RS), SSB (DL RS), or SRS (UL RS). If an UL channel or signal is spatially related to a DL RS, it means that the wireless device should transmit the UL channel or signal with the same beam used in receiving the DL RS, previously. More precisely, the wireless device may transmit the UL channel or signal with the same spatial domain transmission filter used for the reception of the DL RS.

If a UL channel or signal is spatially related to an UL SRS, then the wireless device may apply the same spatial domain transmission filter for the transmission for the UL channel or signal as the one used to transmit the SRS.

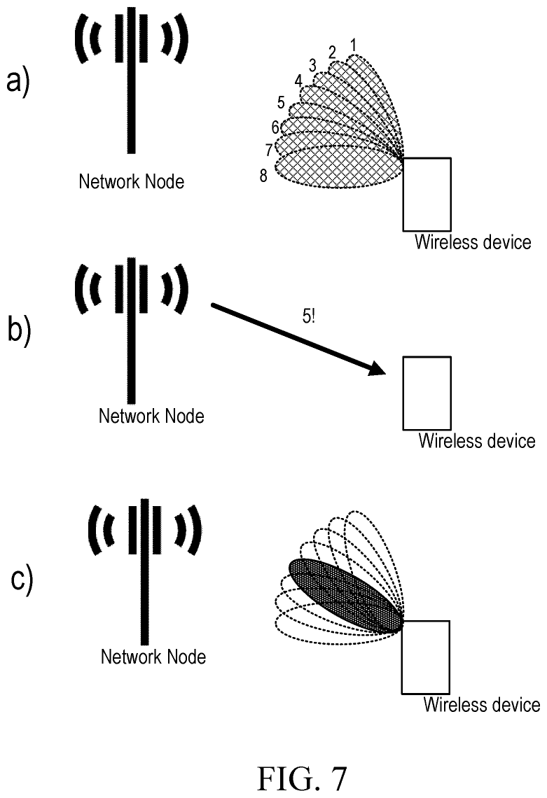

Using DL RSs as the source RS in a spatial relation may be effective when the wireless device can transmit the UL signal in the opposite direction from which it previously received the DL RS, i.e., when the wireless device can achieve the same Tx antenna gain during transmission as the antenna gain it achieved during reception. This capability (known as beam correspondence) will not always be perfect: due to, e.g., imperfect calibration, the UL Tx beam may point in another direction, resulting in a loss in UL coverage. To improve the performance in this situation, UL beam management based on SRS sweeping can be used, as outlined in FIGS. 7a-c. To achieve optimum performance, the procedure depicted in FIGS. 7a-c may be repeated as soon as the wireless devices Tx beam changes. Thus, FIGS. 7a-c shows UL beam management using an SRS sweep. In the first step (FIG. 7a), the wireless device transmits a series of UL signals (SRS resources), using different Tx beams. The network node then performs measurements for each of the SRS transmissions, and determines which SRS transmission was received with the best quality, or highest signal quality. The network node then signals the preferred SRS resource to the wireless device, (FIG. 7b). The wireless device subsequently transmits the PUSCH in the same beam where it transmitted the preferred SRS resource, (FIG. 7c).

For PUCCH, up to 64 spatial relations can be configured for a wireless device and one of the spatial relations is activated by a Medium Access Control (MAC) Control Element (CE) for each PUCCH resource.

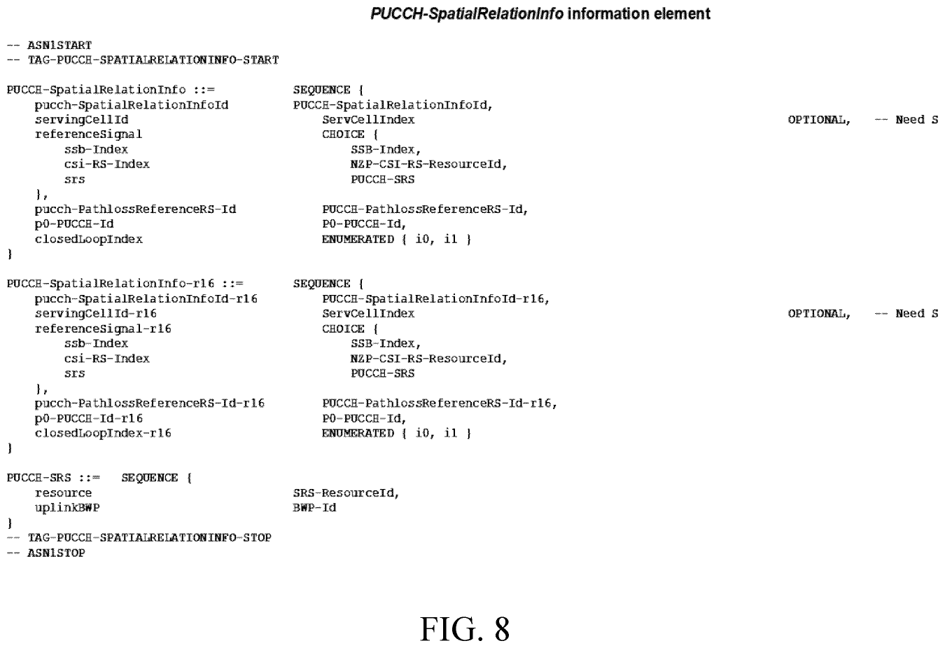

FIG. 8 is a PUCCH spatial relation information element (IE) that a wireless device can be configured with in NR. The IE includes one of an SSB index, a CSI-RS resource identity (ID), and SRS resource ID, as well as some power control parameters such as pathloss RS, closed-loop index, etc.

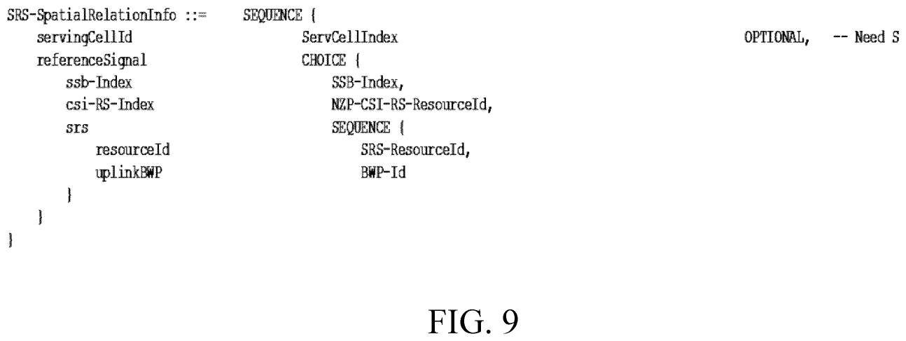

For each periodic and semi-persistent SRS resource or aperiodic SRS with usage “non-codebook” configured, the associated DL CSI-RS is radio resource control (RRC) configured. For each aperiodic SRS resource with usage “codebook” configured, the associated DL RS is specified in a SRS spatial relation activated by a MAC CE. An example of an SRS spatial relation IE is shown in FIG. 9 where one of an SSB index, a CSI-RS resource identity (ID), and SRS resource ID is configured.

In NR, several signals can be transmitted from different antenna ports of a same network node. These signals can have the same large-scale properties such as Doppler shift/spread, average delay spread, or average delay. These antenna ports are then said to be quasi co-located (QCL).

If the wireless device knows that two antenna ports are QCL with respect to a certain parameter (e.g., Doppler spread), the wireless device can estimate that parameter based on one of the antenna ports and apply that estimate for receiving signals on the other antenna port.

For example, there may be a QCL relation between a CSI-RS for tracking RS (tracking reference signal (TRS)) and the PDSCH demodulation reference signal (DMRS). When the wireless device receives the PDSCH DMRS, the wireless device can use the measurements already made on the TRS to assist the DMRS reception.

Information about what assumptions can be made regarding QCL is signaled to the wireless device from the network. In NR, four types of QCL relations between a transmitted source RS and transmitted target RS have been defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced to facilitate beam management with analog beamforming and is known as spatial QCL. There is currently no strict definition of spatial QCL, but the understanding is that if two transmitted antenna ports are spatially QCL, the wireless device can use the same Rx beam to receive them. This is helpful for a wireless device that uses analog beamforming to receive signals, since the wireless device may need to adjust its RX beam in some direction prior to receiving a certain signal. If the wireless device knows that the signal is spatially QCL with some other signal it has received earlier, then the wireless device can safely use the same RX beam to receive also this signal. Note that for beam management, the discussion mostly revolves around QCL Type D, but it is also necessary to convey a Type A QCL relation for the RSs to the wireless device, so that it can estimate all the relevant large-scale parameters.

Typically, this is achieved by configuring the wireless device with a CSI-RS for tracking (TRS) for time and/or frequency offset estimation. To be able to use any QCL reference, the wireless device would have to receive the QCL reference with a sufficiently good signal to interference plus noise ratio (SINR). In many cases, this means that the TRS must be transmitted in a suitable beam to a certain wireless device.

To introduce dynamics in beam and transmission point (TRP) selection, the wireless device can be configured through RRC signaling with up to 128 TCI (Transmission Configuration Indicator) states. The TCI state information element is shown below:

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI state contains QCL information related to one or two RSs. For example, a TCI state may contain CSI-RS1 associated with QCL Type A and CSI-RS2 associated with QCL TypeD. If a third RS, e.g., the PDCCH DMRS, has this TCI state as QCL source, it means that the wireless device can derive Doppler shift, Doppler spread, average delay, delay spread from CSI-RS1 and a spatial Rx parameter (i.e., indicating the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via MAC CE one TCI state for PDCCH (i.e., provides a TCI for PDCCH) and up to eight TCI states for PDSCH. The number of active TCI states the wireless device support is a wireless device capability, but the maximum is 8.

Assume a wireless device has 4 activated TCI states (from a list of totally 64 configured TCI states). Hence, 60 TCI states are inactive for this particular wireless device and the wireless device needs not be prepared to have large scale parameters estimated for those inactive TCI states. But the wireless device continuously tracks and updates the large-scale parameters for the RSs in the 4 active TCI states. When scheduling a PDSCH to a wireless device, the DCI contains a pointer to one activated TCI state. The wireless device then knows which large scale parameter estimate to use when performing PDSCH DMRS channel estimation and PDSCH demodulation.

The existing way of using spatial relations for UL beam indication in NR is cumbersome and inflexible. To facilitate UL beam selection for wireless devices equipped with multiple panels, a unified TCI framework will be introduced in 3GPP Rel-17. Similar to DL, where TCI states are used to indicate DL beams/TRPs, TCI states may also be used to select UL panels and beams used for UL transmissions (i.e., PUSCH, PUCCH, and SRS).

For the 3GPP Rel-17 TCI state framework, a wireless device can be configured with one out of two possible operation modes:
“Joint DL/UL TCI”, where one common beam is used for both DL and UL signals/channels; and
“Separate DL/UL TCI”, where one common beam can be used for DL signals/channels and a separate common beam can be used for UL signals/channels.

For “Joint DL/UL TCI”, a single TCI state (Joint TCI state) is used to determine a transmit/receive (TX/RX) spatial filter for both DL signals and channels and UL signals and channels. For “Separate DL/UL TCI”, one DL TCI state can be used to indicate a RX spatial filter for DL signals/channels and a UL TCI state can be used to indicate TX spatial filter for UL signals/channels.

According to the 3GPP IAB 3GPP TS 38.874, the backhaul link discovery and measurement procedure is performed in two stages:
Stage 1: initial IAB node discovery which follows the same Rel-15 initial access procedure; and
Stage 2: inter-IAB node discovery and measurement.

In Stage 2, there are two SSB-based solutions for IAB inter-node measurement identified. In this case, the design should take into account the half-duplex constraint at an IAB node and multi-hop topologies.

### Extract from 3GPP Technical Reference (TR) 38.874

SSB-based solutions (Solution 1-A and 1-B):
Solution 1-A) Reusing the same set of SSBs used for access wireless devices:
In this case, the SSBs for inter-IAB cell search in stage 2 are on the currently defined sync raster for a SA frequency layer, while for a NSA frequency layer the SSBs are transmitted inside of the SMTC configured for access wireless devices.
Solution 1-B) Use of SSBs which are orthogonal (TDM and/or FDM) with SSBs used for access wireless devices:
In this case, the SSBs, that may get muted, for inter-IAB cell search and measurement in stage 2 are not on the currently defined sync raster for a SA frequency layer, while for a NSA frequency layer the SSBs are transmitted outside of the SMTC configured for access wireless devices.

An IAB node should not mute its own SSB transmissions targeting wireless device cell search and measurement when doing inter-IAB cell search in stage 2:
For SA, this means that SSBs transmitted on the currently defined sync raster follow the currently defined periodicity for initial access.
In case of Solution 1-B, this implies SSBs, that may get muted, for inter-IAB stage 2 cell search is at least TDM with SSBs used for wireless device cell search and measurements.

### End Extract from 3GPP TR 38.874

Solution 1-A, which uses the on-raster SSBs, is already supported by the current 3GPP Rel-15 specification. Additional flexibility in SSB configurations is introduced to the off-raster SSBs used in Solution 1-B, also referred to as 3GPP Rel-16 IAB-specific SSBs:

The configurable values of the parameters in STC for IAB node discovery and measurement are provided in the following:
SSB center frequency:
   a) ARFCN-ValueNR:
SSB subcarrier spacing:
   a) FR1: 15 khz, 30 khz;
   b) FR2: 120 khz, 240 khz:
SSB transmission periodicity:
   a) 5 ms, 10 ms, 20 ms, 40 ms, 80 ms, 160 ms, 320 ms, 640 ms (considered in RAN1 #96bis):
SSB transmission timing offset in half frame(s):
   a) [0, . . . , (number of half frames within SSB transmission periodicity)−1]:
The index of SSBs to transmit (the SSBs to be transmitted in the half frame):
   a) Same as Rel-15.

The configurable values of the parameters in the SSB reception configurations including SSB based measurement timing configuration (SMTC) for IAB node discovery and measurement are provided in the following:
SMTC window periodicity:
   a) 5 ms, 10 ms, 20 ms, 40 ms, 80 ms, 160 ms, 320 ms, 640 ms, 1280 ms;
SMTC window timing offset:
   a) [0, . . . , (number of subframes within SMTC window periodicity)−1]:
SMTC window duration:
   a) [1, . . . , 5] (subframes):
      i) FFS larger than 5:
List of physical cell IDs to be measured:
   a) [cell ID 0, . . . , cell ID M−1]:
SSB-ToMeasure:
   a) Same as Rel-15.

3GPP Rel-16 IAB considers the time-division multiplexing (TDM) case where the IAB-MT and IAB-DU resource of the same IAB node are separated in time. The beam management procedure and signaling for the parent backhaul link and child backhaul link can be performed completely independently. For example, the DL beam indication for the parent backhaul link includes information about the parent node IAB-DU activating a TCI-state in the DL TCI configuration. The TCI configuration is configured by the donor-CU for the parent-node IAB-DU (in terms of parent-DU SSB/CSI-RS) to adjust the DL receive beam of the IAB-MT. While the UL beam indication for the parent backhaul link includes information about the parent-DU activating a TCI-state of the UL TCI configuration.

The UL TCI configuration is configured by the donor-CU for the parent-node IAB-DU (in terms of parent-DU SSB/CSI-RS, or IAB-MT SRS) to adjust the UL transmit beam of the IAB-MT. Similarly, the DL beam indication for the child backhaul link has information about the IAB-DU activating a TCI-state in the DL TCI configuration. This TCI configuration is configured by the donor-CU for the IAB-DU (in terms of IAB-DU SSB/CSI-RS), to adjust the DL receive beam of the child-node IAB-MT. The UL beam indication for the child backhaul link has information about the IAB-DU activating a spatial relation (for Rel-15/16 beam management framework) or a TCI-state of the UL TCI configuration (for Rel-17 beam management framework). This is configured by the donor-CU for the IAB-DU (in terms of IAB-DU SSB/CSI-RS, or child-MT SRS) to adjust the UL transmit beam of the child-MT. In the TDM operation mode, the four TCI configurations (parent-DU DL/UL TCI (spatial relation), IAB-DU DL/UL TCI (spatial relation)) can be separated.

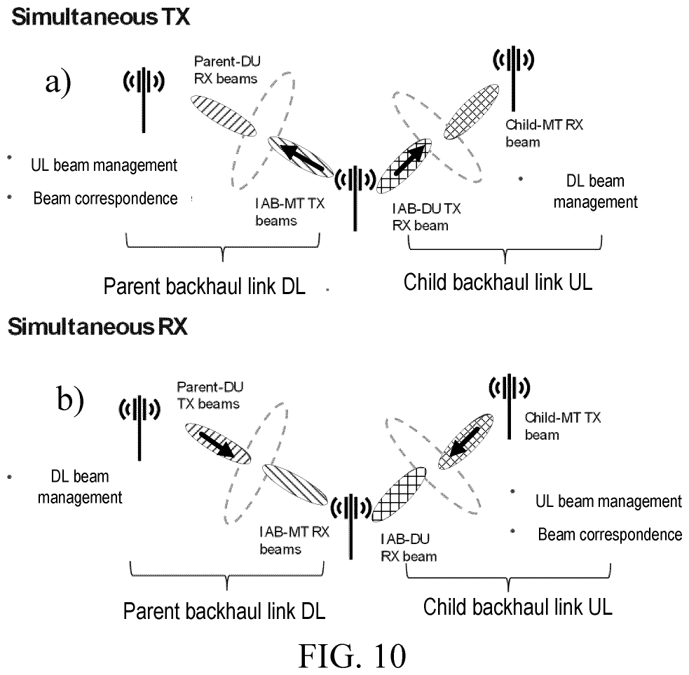

For simultaneous operation, when an IAB node is capable of SDM, the IAB-MT and IAB-DU can use the same time- and frequency-domain resource simultaneously. As illustrated in FIGS. 10a-b, for simultaneous TX (MT TX/DU TX), the UL transmission over the parent backhaul link and the DL transmission over the child backhaul link take place at the same time (note that the child backhaul link also can be a DL access link to a wireless device served by the IAB-DU). To limit the interference from IAB-DU transmission to IAB-MT transmission (or rather the reception of such a transmission), the parent node can indicate to the IAB node a set of restricted IAB-DU TX beams. This means the IAB-MT TX beam used in the parent backhaul link may have impact on DL TCI states for the child link. Similarly, for simultaneous RX (MT RX/DU RX), the DL transmission over the parent backhaul link and the UL transmission over the child link take place at the same time. In this case, the IAB-MT RX beam used for the parent backhaul link will have impact on UL TCI states for the child link.

Based at least on the above, a solution is needed in the SDM case such as to, for example, associate the set of restricted IAB-DU beams to the IAB-DU DL/UL TCI configurations to facilitate the simultaneous operation over the parent backhaul link and the child backhaul link. One or more embodiments of the present disclose solve one or more issues described above by, for example, configuring beam restriction for IAB node(s) and/or providing TCI configuration for IAB nodes, as described herein.

Before describing in detail example embodiments, it is noted that the embodiments reside primarily in combinations of apparatus components and processing steps related to configuring beam restriction for IAB node(s) and/or transmission configuration indicator (TCI) configurations for integrated and backhaul (IAB) spatial domain simultaneous operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node (e.g., parent IAB node, child IAB node, etc.), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (wireless device) such as a wireless device (wireless device) or a radio network node.

In some embodiments, the non-limiting terms wireless device (wireless device) or a user equipment (UE) are used interchangeably. The wireless device herein can be any type of wireless device capable of communicating with a network node or another wireless device over radio signals, such as wireless device (wireless device). The wireless device may also be a radio communication device, target device, device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments relate to configuring beam restriction for IAB node(s).

Some embodiments provide transmission configuration indicator (TCI) configurations for integrated access and backhaul (IAB) spatial domain simultaneous operation.

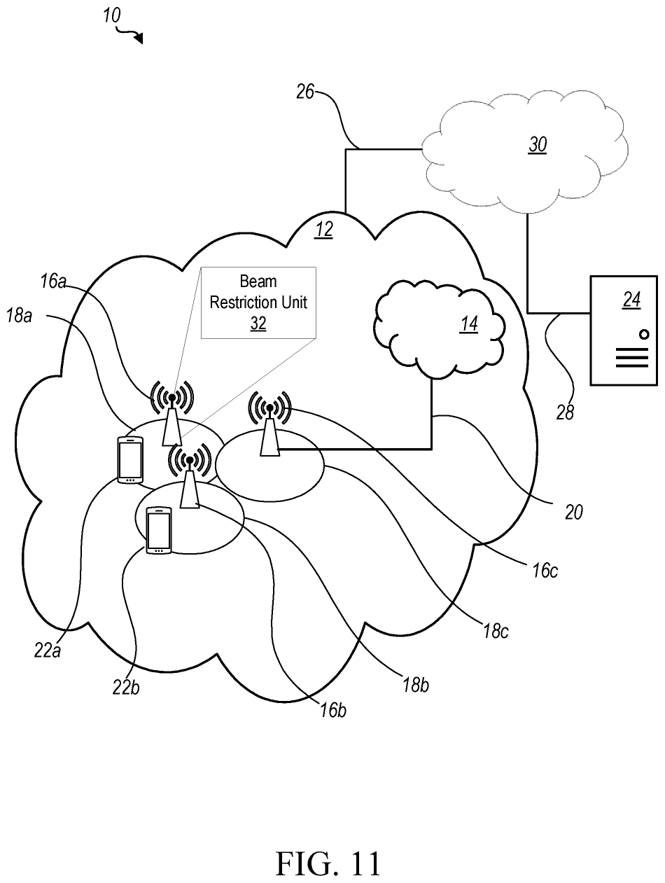

Referring again to the drawing figures, in which like elements are referred to by like reference numerals, there is shown in FIG. 11 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. In one or more embodiments, network node 16 is referred to as IAB node 16 (e.g., parent IAB node 16, child IAB node 16, IAB node 16, etc.). A first wireless device 22a located in coverage area 18a is configured to wirelessly connect to, or be paged by, the corresponding network node 16a. A second wireless device 22b in coverage area 18b is wirelessly connectable to the corresponding network node 16b. While a plurality of wireless devices 22a, 22b (collectively referred to as wireless devices 22) are illustrated in this example, the disclosed embodiments are equally applicable to a situation where a sole wireless device is in the coverage area or where a sole wireless device is connecting to the corresponding network node 16. Note that although only two wireless devices 22 and three network nodes 16 are shown for convenience, the communication system may include many more wireless devices 22 and network nodes 16.

Also, it is contemplated that a wireless device 22 can be in simultaneous communication and/or configured to separately communicate with more than one network node 16 and more than one type of network node 16. For example, a wireless device 22 can have dual connectivity with a network node 16 that supports LTE and the same or a different network node 16 that supports NR. As an example, wireless device 22 can be in communication with an eNB for LTE/E-UTRAN and a network node for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 11 as a whole enables connectivity between one of the connected wireless devices 22a, 22b and the host computer 24. The connectivity may be described as an over-the-top (OTT) connection. The host computer 24 and the connected wireless devices 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected wireless device 22a. Similarly, the network node 16 need not be aware of the future routing of an outgoing uplink communication originating from the wireless device 22a towards the host computer 24.

A network node 16 is configured to include a beam restriction unit 32 which is configured to perform one or more network node functions as described herein such as, for example, perform one or more IAB node 16 (e.g., parent IAB node 16, child IAB nodes 16, etc.) functions described herein. For example, in one or more embodiments, beam restriction unit 32 is configured to determine a set of restricted IAB-data unit, IAB-DU, beams of a child IAB node 16 based at least in part on IAB-specific synchronization signal blocks, SSBs.

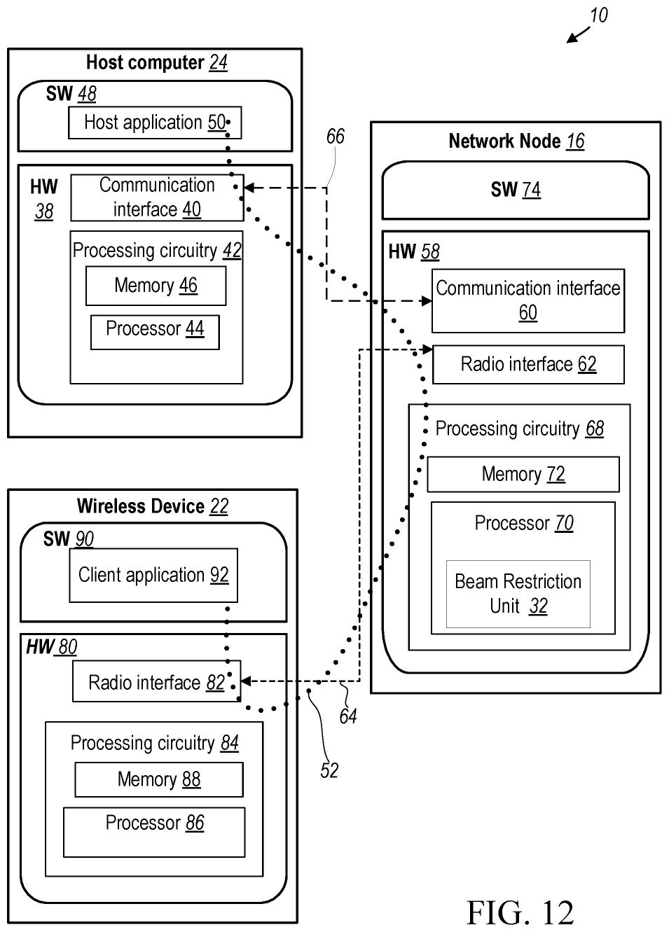

Example implementations, in accordance with an embodiment, of the wireless device 22, network node 16 and host computer 24 discussed in the preceding paragraphs will now be described with reference to FIG. 12. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a wireless device 22 connecting via an OTT connection 52 terminating at the wireless device 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the wireless device 22. The hardware 58 may include a communication interface 60 for setting up and maintaining a wired or wireless connection with an interface of a different communication device of the communication system 10, as well as a radio interface 62 for setting up and maintaining at least a wireless connection 64 with a wireless device 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a beam restriction unit 32 which is configured to perform one or more network node functions as described herein such as, for example, determining a set of restricted IAB-data unit, IAB-DU, beams of a child IAB node 16 based at least in part on IAB-specific synchronization signal blocks, SSBs.

The communication system 10 further includes the wireless device 22 already referred to. The wireless device 22 may have hardware 80 that may include a radio interface 82 configured to set up and maintain a wireless connection 64 with a network node 16 serving a coverage area 18 in which the wireless device 22 is currently located. The radio interface 82 may be formed as or may include, for example, one or more RF transmitters, one or more RF receivers, and/or one or more RF transceivers.

The hardware 80 of the wireless device 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the wireless device 22 may further comprise software 90, which is stored in, for example, memory 88 at the wireless device 22, or stored in external memory (e.g., database, storage array, network storage device, etc.) accessible by the wireless device 22. The software 90 may be executable by the processing circuitry 84. The software 90 may include a client application 92. The client application 92 may be operable to provide a service to a human or non-human user via the wireless device 22, with the support of the host computer 24. In the host computer 24, an executing host application 50 may communicate with the executing client application 92 via the OTT connection 52 terminating at the wireless device 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by wireless device 22. The processor 86 corresponds to one or more processors 86 for performing wireless device 22 functions described herein. The wireless device 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to wireless device 22.

In some embodiments, the inner workings of the network node 16, wireless device 22, and host computer 24 may be as shown in FIG. 12 and independently, the surrounding network topology may be that of FIG. 11.

In FIG. 12, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the wireless device 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the wireless device 22 and the network node 16 is in accordance with the teachings of the embodiments described throughout this disclosure. One or more of the various embodiments improve the performance of OTT services provided to the wireless device 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and wireless device 22, in response to variations in the measurement results. The measurement procedure and/or the network functionality for reconfiguring the OTT connection 52 may be implemented in the software 48 of the host computer 24 or in the software 90 of the wireless device 22, or both. In embodiments, sensors (not shown) may be deployed in or in association with communication devices through which the OTT connection 52 passes: the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.: the reconfiguring need not affect the network node 16, and it may be unknown or imperceptible to the network node 16. Some such procedures and functionalities may be known and practiced in the art. In certain embodiments, measurements may involve proprietary wireless device signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the wireless device 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the wireless device 22, and/or preparing/terminating/maintaining/supporting/ending in receipt of a transmission from the wireless device 22.

In some embodiments, the host computer 24 includes processing circuitry 42 and a communication interface 40 that is configured to a communication interface 40 configured to receive user data originating from a transmission from a wireless device 22 to a network node 16. In some embodiments, the wireless device 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 11 and 12 show “unit” such as beam restriction unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

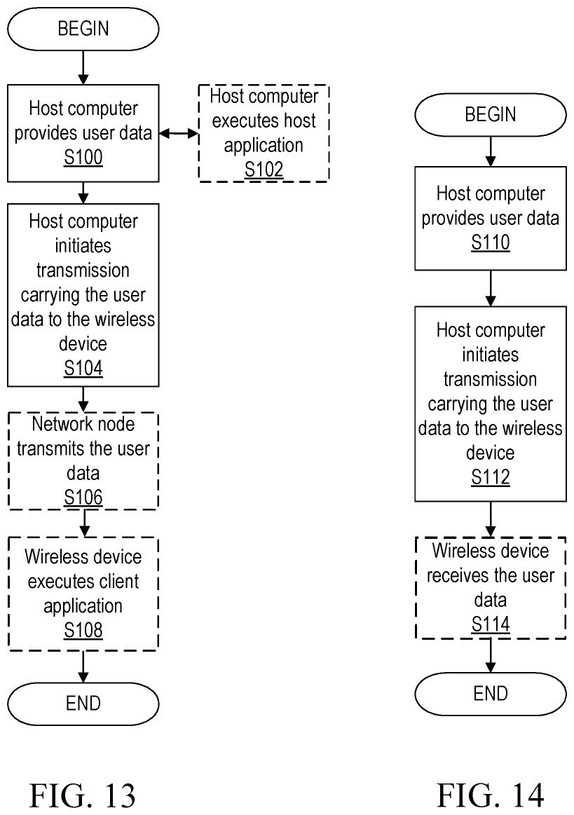

FIG. 13 is a flowchart illustrating an example method implemented in a communication system, such as, for example, the communication system of FIGS. 11 and 12, in accordance with one embodiment. The communication system may include a host computer 24, a network node 16 and a wireless device 22, which may be those described with reference to FIG. 12. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the wireless device 22 (Block S104). In an optional third step, the network node 16 transmits to the wireless device 22 the user data which was carried in the transmission that the host computer 24 initiated, in accordance with the teachings of the embodiments described throughout this disclosure (Block S106). In an optional fourth step, the wireless device 22 executes a client application, such as, for example, the client application 92, associated with the host application 50 executed by the host computer 24 (Block S108).

FIG. 14 is a flowchart illustrating an example method implemented in a communication system, such as, for example, the communication system of FIG. 11, in accordance with one embodiment. The communication system may include a host computer 24, a network node 16 and a wireless device 22, which may be those described with reference to FIGS. 11 and 12. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the wireless device 22 (Block S112). The transmission may pass via the network node 16, in accordance with the teachings of the embodiments described throughout this disclosure. In an optional third step, the wireless device 22 receives the user data carried in the transmission (Block S114).

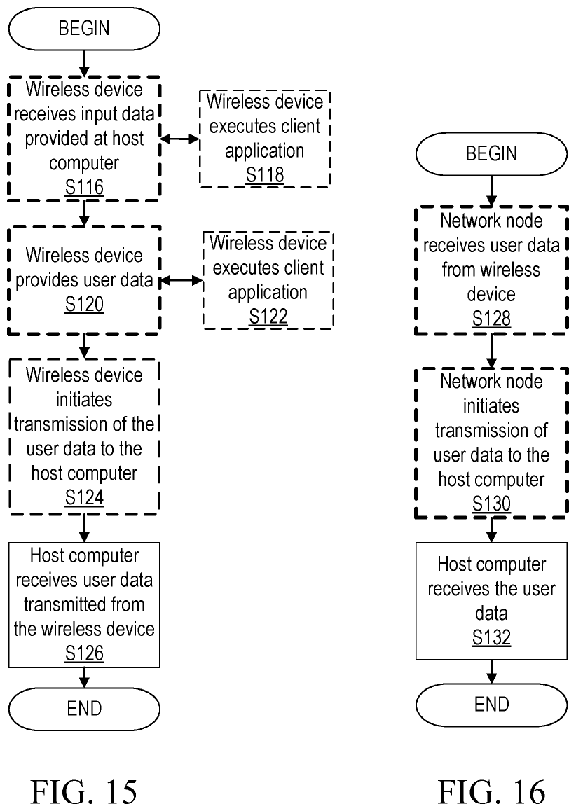

FIG. 15 is a flowchart illustrating an example method implemented in a communication system, such as, for example, the communication system of FIG. 11, in accordance with one embodiment. The communication system may include a host computer 24, a network node 16 and a wireless device 22, which may be those described with reference to FIGS. 11 and 12. In an optional first step of the method, the wireless device 22 receives input data provided by the host computer 24 (Block S116). In an optional substep of the first step, the wireless device 22 executes the client application 92, which provides the user data in reaction to the received input data provided by the host computer 24 (Block S118). Additionally or alternatively, in an optional second step, the wireless device 22 provides user data (Block S120). In an optional substep of the second step, the wireless device provides the user data by executing a client application, such as, for example, client application 92 (Block S122). In providing the user data, the executed client application 92 may further consider user input received from the user. Regardless of the specific manner in which the user data was provided, the wireless device 22 may initiate, in an optional third substep, transmission of the user data to the host computer 24 (Block S124). In a fourth step of the method, the host computer 24 receives the user data transmitted from the wireless device 22, in accordance with the teachings of the embodiments described throughout this disclosure (Block S126).

FIG. 16 is a flowchart illustrating an example method implemented in a communication system, such as, for example, the communication system of FIG. 11, in accordance with one embodiment. The communication system may include a host computer 24, a network node 16 and a wireless device 22, which may be those described with reference to FIGS. 11 and 12. In an optional first step of the method, in accordance with the teachings of the embodiments described throughout this disclosure, the network node 16 receives user data from the wireless device 22 (Block S128). In an optional second step, the network node 16 initiates transmission of the received user data to the host computer 24 (Block S130). In a third step, the host computer 24 receives the user data carried in the transmission initiated by the network node 16 (Block S132).

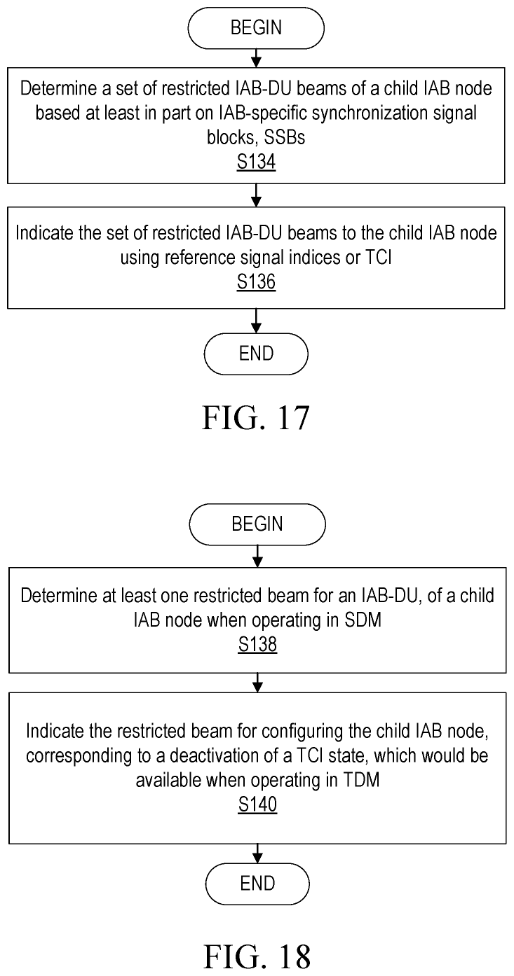

FIG. 17 is a flowchart of an example process in a network node 16 for configuring beam restriction for IAB node(s) and/or TCI configurations for IAB spatial domain simultaneous operation. One or more blocks described herein may be performed by one or more elements of network node 16 such as by one or more of processing circuitry 68 (including the beam restriction unit 32), processor 70, radio interface 62 and/or communication interface 60. Network node 16 is configured to determine (Block S134) a set of restricted IAB-data unit, IAB-DU, beams of a child IAB node 16 based at least in part on IAB-specific synchronization signal blocks, SSBs. The network node 16 is configured to indicate (Block S136) the set of restricted IAB-DU beams to the child IAB node 16 using reference signal indices or transmission configuration indicator, TCI.

FIG. 18 is a flowchart of an example process in a network node 16 according to one or more embodiments of the present disclosure. In one or more embodiments, network node 16 is an IAB node 16 such as, for example, a parent IAB node 16. One or more blocks described herein may be performed by one or more elements of network node 16 such as by one or more of processing circuitry 68 (including the beam restriction unit 32), processor 70, radio interface 62 and/or communication interface 60. The network node 16 is configured to determine (Block S138) at least one restricted beam for an IAB-distributed unit, IAB-DU, of a child IAB node 16 when operating in spatial division multiplexing, SDM, as described herein. The network node 16 is configured to indicate (Block S140) the at least one restricted beam for configuring the child IAB node 16 where the indication of the at least one restricted beam corresponds to a deactivation of a Transmission Configuration Indicator, TCI state, which would be available when operating in time division multiplexing, TDM, as described herein. In one or more embodiments, the indication of the at least one restricted beam for configuring the child IAB node 16 relates to a parent IAB-DU indicating the restricted beam to the IAB-DU using/associating to its (parent IAB-DU) TCI states.

In one or more embodiments, the indication of the at least one restricted beam for configuring the child IAB node 16 relates to the IAB-DU configuring (e.g., deactivating) the restricted beams towards the child IAB-MT, using its (IAB-DU) TCI states.

According to one or more embodiments, the indication is communicated to the child IAB node 16. According to one or more embodiments, the at least one restricted beam is configured to restrict selection to one of: the at least one restricted beam: another beam that is located within the at least one restricted beam; and another beam that partially overlaps with the at least one restricted beam. According to one or more embodiments, the indication of the at least one restricted beam is associated with at least one TCI state such as, for example, at least one TCI state of the parent IAB-DU and/or IAB-DU, etc.

According to one or more embodiments, the indication is provided by signaling individually per carrier. According to one or more embodiments, the at least one restricted beam corresponds to a plurality of restricted beams to be applied to one of: a single carrier, subset of a plurality of carriers and the plurality of carriers. According to one or more embodiments, the at least one restricted beam is indicated by one of: Medium Access Control-Control Element, MAC-CE signaling, at least one SSB index in MAC-CE signaling, and at least one Channel State Information-Reference Signal, CSI-RS, resource index in MAC-CE signaling.

According to one or more embodiments, the restriction of the at least one restricted beam is configured to be considered by the child IAB node 16 operating in SDM operation mode, where the restriction of the at least one restricted beam is configured to be disregarded by the child IAB node 16 operating in TDM operation mode. According to one or more embodiments, the indication is transmitted to a Donor IAB node 16. According to one or more embodiments, the processing circuitry 68 is further configured to activate one of a TDM operation mode and SDM operation mode at the child IAB node 16 where the at least one restricted beam is associated with the SDM operation mode and not the TDM operation mode.

According to one or more embodiments, the at least one restricted beam corresponds to at least one downlink beam used for communication from the child IAB node 16 to a first IAB node 16. According to one or more embodiments, the at least one restricted beam allows the IAB-DU and IAB-Mobile Termination, IAB-MT, of the child IAB node 16 to simultaneously use the same resources.

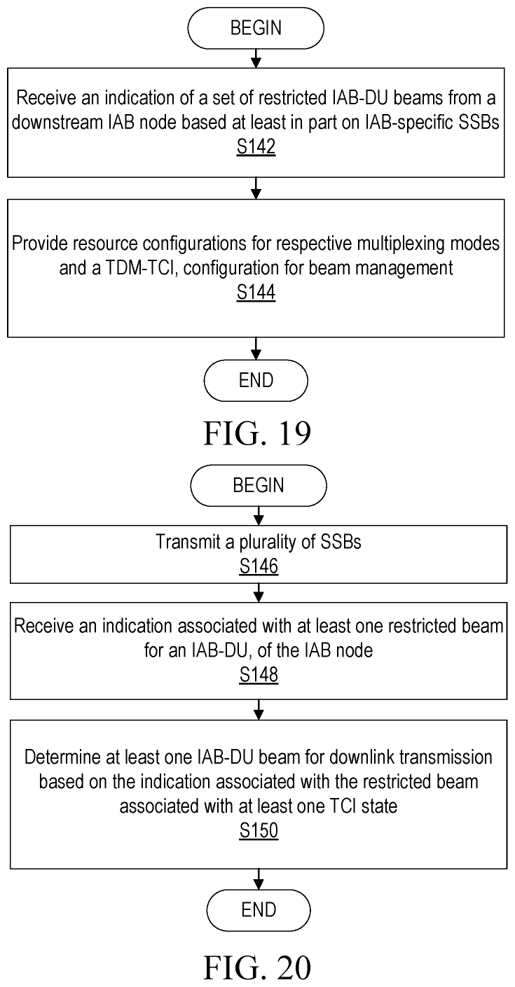

FIG. 19 is a flowchart of another example process in a network node 16 according to some embodiments of the present. In one or more embodiments, network node 16 is an IAB node 16 such as, for example, a parent IAB node 16. One or more blocks described herein may be performed by one or more elements of network node 16 such as by one or more of processing circuitry 68 (including the beam restriction unit 32), processor 70, radio interface 62 and/or communication interface 60. Network node 16 is configured to receive (Block S142) an indication of a set of restricted IAB-data unit, IAB-DU, beams from a downstream IAB node 16 based at least in part on IAB-specific synchronization signal blocks, SSBs. The network node 16 is configured to provide (Block S144) the downstream IAB node 16 with resource configurations for respective multiplexing modes of the downstream IAB node 16 and a time division multiplexed-transmission configuration indicator, TDM-TCI, configuration for beam management.

FIG. 20 is a flowchart of another example process in a network node 16 according to one or more embodiments of the present disclosure. In one or more embodiments, network node 16 is an IAB node 16 such as, for example, a parent IAB node 16. One or more blocks described herein may be performed by one or more elements of network node 16 such as by one or more of processing circuitry 68 (including the beam restriction unit 32), processor 70, radio interface 62 and/or communication interface 60. The network node 16 is configured to transmit (Block S146) a plurality of synchronization signal blocks, SSBs, as described herein. The network node 16 is configured to receive (Block S148) an indication associated with at least one restricted beam for an IAB-distributed unit, IAB-DU, of the IAB node 16, as described herein. The network node 16 is configured to determine (Block S150) at least one IAB-DU beam for downlink transmission based at least on the indication associated with the at least one restricted beam where the indication of the at least one restricted beam is associated with at least one Transmission Configuration Indicator, TCI, state

According to one or more embodiments, the indication is an explicit indication of the at least one restricted beam received from a parent IAB node 16. According to one or more embodiments, the processing circuitry 68 is further configured to, based on the indication, avoid selecting one of: the at least one restricted beam: another beam that is located within the at least one restricted beam; and another beam that partially overlaps with the at least one restricted beam. According to one or more embodiments, the indication is provided by signaling individually per carrier.

According to one or more embodiments, the at least one restricted beam corresponds to a plurality of restricted beams to be applied to one of: a single carrier, subset of a plurality of carriers and the plurality of carriers. According to one or more embodiments, the at least one restricted beam is indicated by one of: Medium Access Control-Control Element, MAC-CE signaling: at least one SSB index in MAC-CE signaling; and at least one Channel State Information-Reference Signal, CSI-RS, resource index in MAC-CE signaling. According to one or more embodiments, the processing circuitry is configured to: consider the restriction of the at least one restricted beam based on the IAB node 16 operating in Spatial Division Multiplexing, SDM, operation mode, and disregard the restriction of the at least one restricted beam based on the IAB node 16 operating in Time Division Multiplexing, TDM, operation mode.

According to one or more embodiments, the indication is a plurality of TCI configurations associated with the at least one restricted beam, the indication being received from a Donor IAB node 16. According to one or more embodiments, the processing circuitry is further configured to activate one of a Time Division Multiplexing, TDM, operation mode and Spatial Division Multiplexing, SDM, operation mode where the at least one restricted beam is associated with the SDM operation mode and not the TDM operation mode. According to one or more embodiments, the at least one restricted beam corresponds to at least one downlink beam used for communication from the IAB node 16 to a child IAB node 16. According to one or more embodiments, the at least one restricted beam allows the IAB-DU and IAB-Mobile Termination, IAB-MT, of the IAB node 16 to simultaneously use the same resources.

Having described the general process flow of arrangements of the disclosure and having provided examples of hardware and software arrangements for implementing the processes and functions of the disclosure, the sections below provide details and examples of arrangements for configuring beam restriction for IAB node(s) and/or TCI configurations for IAB spatial domain simultaneous operation.

One or more network node 16 (e.g., IAB node 16) functions described below may be performed by one or more of processing circuitry 68, processor 70, beam restriction unit 32, etc.

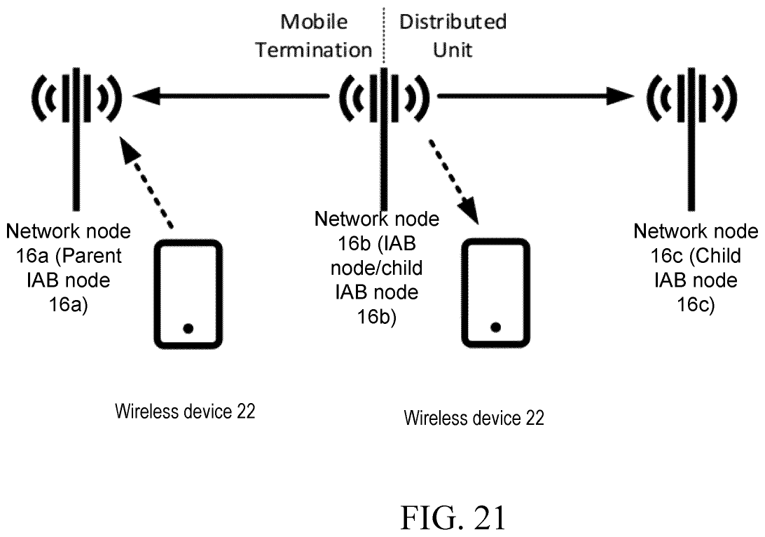

FIG. 21 illustrates an IAB system according to some embodiments described herein. In FIG. 21, a network node 16a may act as a parent IAB node 16 and a network node 16b may act as a child IAB node 16. The parent network node 16 may be configured to perform the functions of the beam restriction unit 32 and the process described with reference to FIGS. 17-18. The network node 16a may also, for example, act as a donor IAB node 16 and/or IAB node 16b and may be configured to perform the process described with reference to FIGS. 19-20.

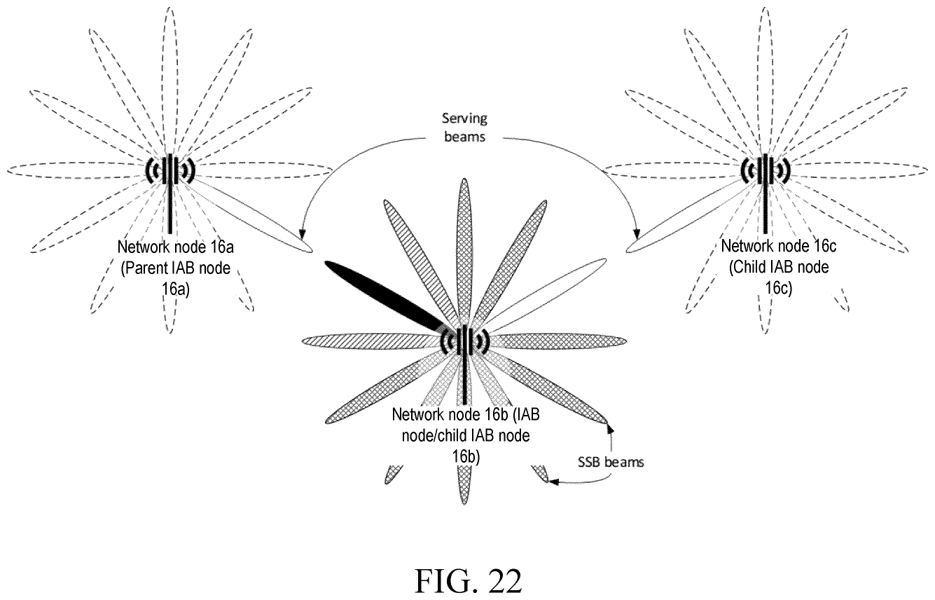

FIG. 22 illustrates an IAB node 16's SSB beams and parent/child IAB nodes' serving beams. The black beam represents an SSB beam, or a beam related to the SSB beam, is used for serving the IAB-MT when communicating with the parent IAB-DU. The white beams indicate a beam used for serving the IAB-DU when communicating with the child IAB-MT. The parent IAB-node's and child IAB-node's respective serving beams are indicated with hashed lines.

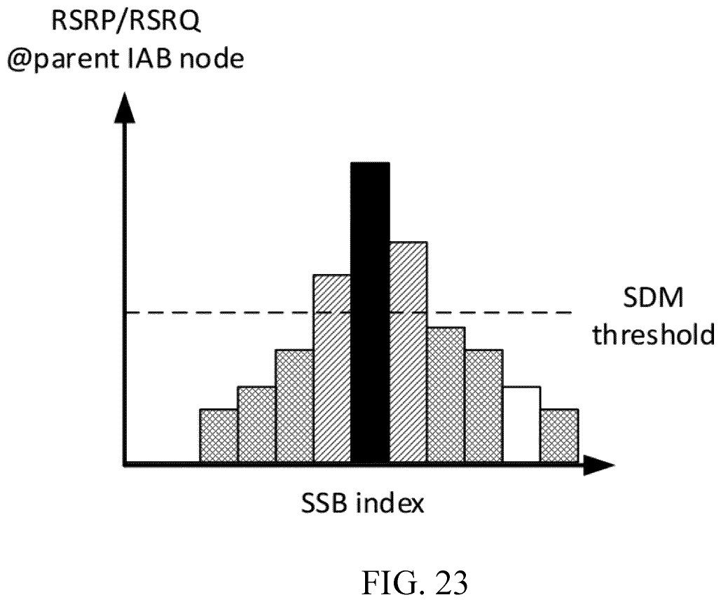

FIG. 23 illustrates received signal strength of different SSB beams at parent IAB-node. Bar patterns are aligned with beam marking patterns in FIG. 23. Some beams may not be detected by the parent IAB node 16 and are therefore not shown.

Referring back to FIG. 21, the system includes an IAB node with an IAB-MT and an IAB-DU. The IAB node 16 is connected upstream to a parent IAB node 16 and may be connected downstream to a child IAB node 16 and/or a wireless device. The Central Unit (CU) may be in the donor node that is a logical unit responsible for higher level functions, e.g., RRC.

Referring back to FIG. 22, the IAB-DU transmits IAB-specific SSB beams in the directions it provides coverage. The solid black beam, or a beam related to it, is the one identified by the parent IAB node as the one being preferred for the IAB-MT to use when communicating with the parent IAB node, i.e., it is the IAB-MT's serving beam when communicating with the parent IAB node. The solid white SSB beam, or a beam related to it, is preferred when the IAB-DU communicates with a child IAB-MT, i.e., it is used when serving the child IAB-MT. The striped SSB beams are beams causing significant interference (e.g., above a threshold for space domain multiplexing in simultaneous operation) in the parent IAB node when the parent IAB node is receiving the black beam, using its serving beam for communication with the IAB-MT and the checked SSB beams are beams causing insignificant interference in the parent IAB node when receiving the solid black beam, using its serving beam for communication with the IAB-MT, as illustrated in FIG. 23. The parent IAB node 16 may not be able to receive all beams from the IAB node 16; such beam is not shown in FIG. 23.

Thus, methods at a parent IAB node 16 to determine the set of restricted IAB-DU beams of the child node are disclosed. Practically, the IAB-specific SSBs are the natural choice for determining restricted IAB-DU beams since these IAB-specific SSBs are designed and developed for inter-IAB node discovery and measurement and SSB is the signal that defines the coverage of a cell. Furthermore, specific CSI-RS beams, carrying the PDSCH, or SRS beams, carrying the PUSCH may both be mapped to a specific SSB, allowing the set to be relevant also for these beams. Comparing this to the normal TCI beam combination, i.e., determining interfering beams instead of selecting a few best beams, using SSBs will provide a sufficient resolution in the beam restriction. Different from the legacy beam management procedure, the IAB-DU should sweep its SSB beams while the parent IAB-MT performs the measurement allowing to determining the set of restricted IAB-DU DL TX beams. In cases when reciprocity applies, the set of restricted IAB-DU DL TX beams can be used to determine the set of restricted IAB-DU UL RX beams.

In this disclosure, the 3GPP Rel-15/Rel-16 beam management framework and Rel-17 beam management framework are interchangeable.

### Embodiment 1: L1/L2 Signaling of Restricted Beams for IAB-DU

In this embodiment, the parent IAB-DU indicates a number of restricted IAB-DU beams by signaling reference signal indices (e.g., SSBRI, CRI, SRI, for SSB, CSI-RS and SRS beams, respectively) or TCI state IDs to the IAB-DU (e.g., IAB node 16), where each reference signal index or TCI state ID is associated to an IAB-DU beam. The indicated IAB-DU beams may be restricted for use when the IAB node 16 is operating in SDM mode (but can still be used when operating in TDM mode). The indication of restricted beams may be done using L1/L2 signaling. The association between reference signal index and an IAB-DU beam is based on earlier transmission of the reference signal from the IAB-DU. For example, assume that an IAB-DU has 4 wide beams, B1, B2, B3 and B4. Assume further that the IAB-DU transmits SSB1 in B1, SSB2 in B2, SSB3 in B3 and SSB4 in B4. Then, if for example SSB1 and SSB2 are signaled to be restricted IAB-DU beams, then the IAB-DU may restrict the beams that can be mapped to the beams where SSB1 and SSB2 has been earlier transmitted (i.e., B1 and B2).

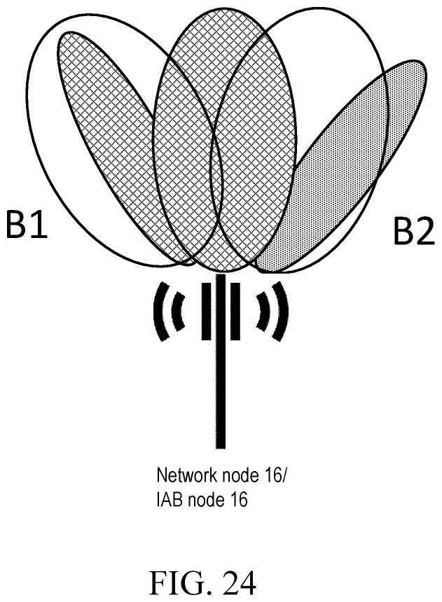

In one alternative of this embodiment, when a beam is restricted, it means that the IAB-DU is not allowed to transmit in using the restricted beam or transmit in another beam that is located within the restricted beam or is partly overlapping with the restricted beams. FIG. 24 shows an example of beams that can be used when a beam (B1) has been restricted. In FIG. 24 it is assumed that B1 is restricted. In this example the two beams with cross hatchings are not allowed to be used by the IAB-DU since they are within or partly overlapping with the restricted beam B1. However, the dotted beam that is not within or partly/fully overlapping with B1 is allowed to be used (as well as B2). Note that this is just one example showing use of partly overlapping beams used that do not greatly overlap.

In one alternative of this embodiment, a MAC-CE message is used to indicate the restricted IAB-DU beams by indicating the corresponding SSB indexes (SSBRIs). In another alternative of this embodiment, the MAC-CE message indicates the restricted IAB-DU beams by indicating the corresponding TCI states. In one alternative of this embodiment, a MAC-CE message is used to indicate the restricted IAB-DU beams by indicating the corresponding CSI-RS resource indexes (CRIs). In an alternative of this embodiment, an IAB-DU consists of multiple serving cells and each serving cell will be configured with reference signals, e.g., SSBs, CSI-RSs, SRSs.

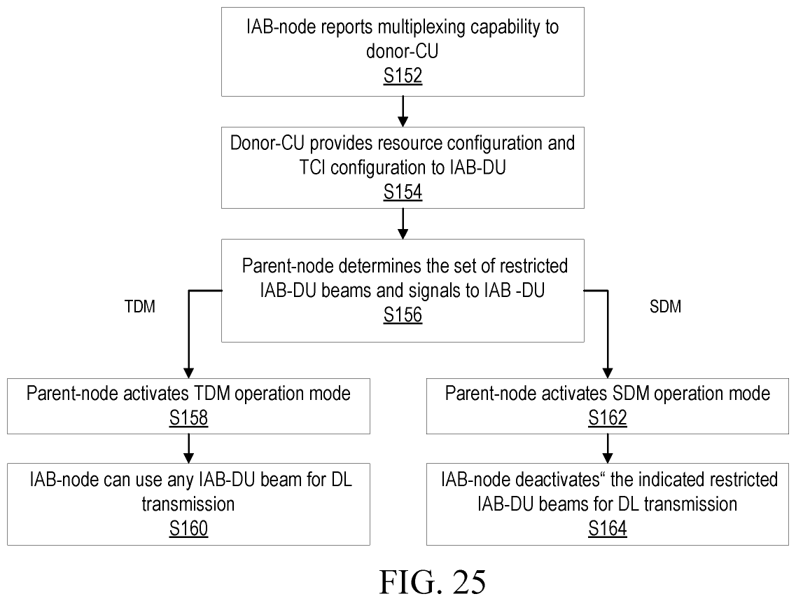

One example of this embodiment is shown in FIG. 25. When an IAB node enters an IAB network, the IAB node 16 will first report its multiplexing capability (e.g., TDM, FDM, SDM) to the donor-CU (Block S152). Based on the reported multiplexing capability, the donor-CU will provide IAB-DU resource configurations for the respective multiplexing modes, and a joint TCI configuration for beam management (Block S154). Thereafter, the parent IAB node 16 determines the set of restricted IAB-DU beams, using for example IAB-specific SSBs (Block S156). The set of restricted IAB-DU beams will be indicated to IAB-DU using L1/L2 signaling. The parent IAB node 16 also activates the TDM operation mode (Block S158,).

During operation, the active multiplexing mode is under control of the parent IAB node. The parent IAB node will send the indication of restricted IAB-DU beams to the IAB node/child IAB node 16.

In one alternative of this embodiment, when operating in the TDM mode, the IAB-DU does not take the indicated restricted IAB-DU beams in to account when scheduling child IAB-MT and/or serving wireless devices for DL transmission (i.e., all IAB-DU beams can be used for DL scheduling), (Block S160). However, when operating in SDM mode (S162), the IAB-DU does not transmit any DL signals in the indicated restricted IAB-DU beams (or any narrow beams within an indicated restricted IAB-DU beam) to a child IAB-MT and/or serving wireless device, in other words the IAB-DU deactivates restricted beams (Block S164).

In one alternative of this embodiment, in case carrier aggregation is used in the IAB system, the indicated restricted IAB-DU beams can be signaled individually per carrier (serving cell). In one alternative of this embodiment, a single indication of restricted beams is signaled, and then applied to one, a subset of or all carriers.

In one alternative of this embodiment, each indicated restricted beam is associated to one or multiple TCI states. And when a certain beam has been indicated as restricted (e.g., by signaling a reference signal index or a TCI state ID), the TCI states (directly or indirectly) associated to each indicated restricted beam are “de-activated” (i.e., the IAB-DU is not allowed to use the de-activated TCI states for DL transmission/scheduling for a child IAB-MT or serving wireless device). This means that, instead of restricting the usage of a certain IAB-DU beam, certain TCI states are restricted for the IAB-DU.

In one embodiment, the TCI states are only deactivated for the subcarriers for which the beam restrictions apply whereas remaining, e.g., frequency resources, i.e., subcarriers, may utilize the full set of TCI states. In a related embodiment, the reduced TCI states are related to soft frequency resources.

In one alternate of this embodiment, in case the IAB-DU uses narrower beams for transmitting data (e.g., PDSCH) than the beams used to transmit the SSBs, the interference received at the parent IAB-MT from the IAB-DU could be significantly stronger during data transmission compared to the estimated interference from the received SSBs. This could lead to some SSB beams being not restricted, even though they should be restricted due to excessive interference. One way to solve this could be to use an additional scaling factor that indicates the gain difference between the transmitted SSBs and the transmitted data from the IAB-DU. The indicated gain difference (scaling factor) could be based on either:
Both output power difference (between the dedicated SSBs and the data transmission) and beamforming gain difference (between the SSB beams and data beam): or
Only based on the beamforming gain difference (between the SSB beams and the data beams).

By using the scaling factor, the parent IAB node can better determine which SSB beams should be restricted since the parent IAB node can in this case better estimate the actual interference that it will be received during actual data transmission. Note that it is the parent IAB node that estimates the interference and therefore may need to be informed about the scaling factor. Hence, in one alternate of this embodiment, the scaling factor is signaled to the parent IAB node from the IAB node (using L1 and/or L2 signaling, for example MAC-CE).

### Embodiment 2: Separated TCI Configurations for IAB TDM and SDM Operations

In one embodiment, the restricted beam set is reported to the donor-CU. Accordingly, the donor-CU may provide a separate TCI configuration for SDM operation. When operating in the time division multiplex (TDM) mode, the IAB-DU can activate all the TCI states (i.e., use the IAB-DU beams associated with all TCI states) in the TDM-TCI configuration to adjust the child-node IAB-MT DL RX beams or UL TX beams. Similarly, when operating in the SDM mode, the IAB-DU can activate all the TCI states in the SDM-TCI configuration (i.e., use the IAB-DU beams associated with all TCI states in the SDM-TCI configuration).

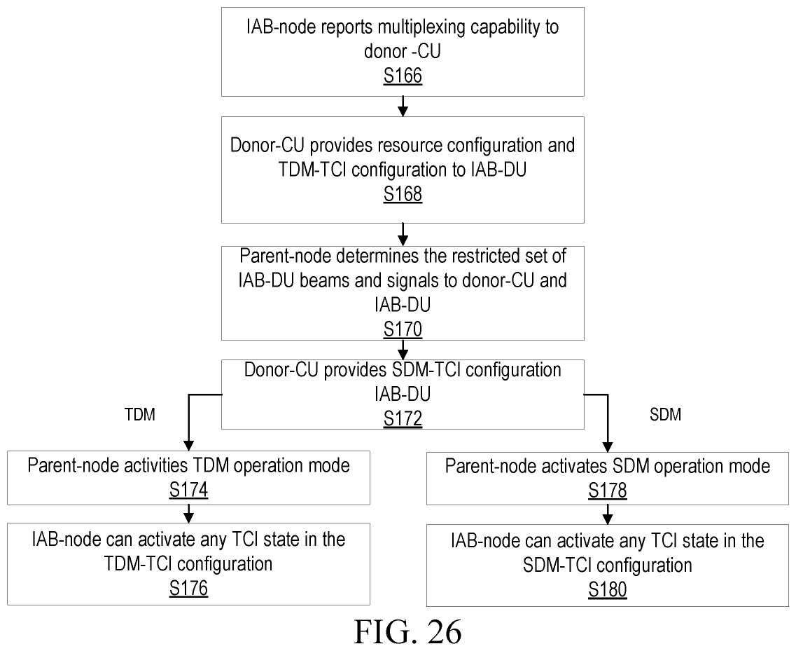

One example is shown in FIG. 26. Based on the reported multiplexing capability (Block S166), the donor-CU provides IAB-DU resource configurations for the respective multiplexing modes, and a TDM-TCI configuration for beam management (Block S168). Thereafter, the parent-node determines the set of restricted IAB-DU beams using IAB-specific SSBs (Block S170). The set of restricted IAB-DU beams may be indicated to the donor-CU using L2/L3 signaling. Based on the set of restricted IAB-DU beams, the donor-CU may provide IAB-DU with a separate SDM-TCI configuration (Block S172). During operation, the parent IAB node may dynamically switch the multiplexing modes according to the operation conditions (Blocks S174). When operating in the TDM mode, the IAB-DU can activate any TCI state to the Child IAB-MT in the TDM-TCI configuration (Block S176). When operating in the SDM mode, the IAB-DU can activate any TCI states to the Child IAB-MT in the SDM-TCI configuration (Blocks S178 and S180).

In one embodiment, the donor-CU can configure the SDM-TCI configuration based on varied combinations of TDM, FDM and SDM operations. In another embodiment, the donor-CU can configure the SDM-TCI configuration taking the H/S/NA configurations into consideration, for example to apply only to soft resources. In yet another embodiment, the donor-CU can configure a TCI-state to only apply to certain Resource Block (RB)-Sets of the serving cell.

### SOME EXAMPLES

According to one aspect, a network node 16 operating as an Internet Access and Backhaul (IAB) node is configured to communicate with at least another IAB node 16, the network node includes a radio interface 62 and/or processing circuitry 68 configured to: determine a set of restricted IAB-data unit, IAB-DU, beams of a child IAB node 16 based at least in part on IAB-specific synchronization signal blocks, SSBs; and indicate the set of restricted IAB-DU beams to the child IAB node 16 using reference signal indices or transmission configuration indicator, TCI.

According to this aspect, in some embodiments, associations between reference signal indices and IAB-DU beams are based on earlier reference signal transmissions from the child IAB node 16. In some embodiments, the indication of the set of restricted IAB-DU beams includes an indication of SSB indices. In some embodiments, the indication of the set of restricted IAB-DU beams includes an indication of TCI states. In some embodiments, the indication of the set of restricted IAB-DU includes a medium access control (MAC) control element (CE) message configured to indicate corresponding channel state information (CSI) resource indices (CRIs).

According to another aspect, a method in a network node 16 operating as an Internet Access and Backhaul (IAB) node includes: determining a set of restricted IAB-data unit, IAB-DU, beams of a child IAB node 16 based at least in part on IAB-specific synchronization signal blocks, SSBs; and indicating the set of restricted IAB-DU beams to the child IAB node 16 using reference signal indices or transmission configuration indicator, TCI.

According to this aspect, in some embodiments, associations between reference signal indices and IAB-DU beams are based on earlier reference signal transmissions from the child IAB node 16. In some embodiments, the indication of the set of restricted IAB-DU beams includes an indication of SSB indices. In some embodiments, the indication of the set of restricted IAB-DU beams includes an indication of TCI states. In some embodiments, the indication of the set of restricted IAB-DU includes an a medium access control (MAC) control element (CE) message configured to indicate corresponding channel state information (CSI) resource indices (CRIs).

According to yet another aspect, a network node 16 operating as an Internet Access and Backhaul (IAB) node, includes a radio interface 62 and/or processing circuitry 68 configured to: receive an indication of a set of restricted IAB-data unit, IAB-DU, beams from a downstream IAB node 16 based at least in part on IAB-specific synchronization signal blocks, SSBs; and provide the downstream IAB node 16 with resource configurations for respective multiplexing modes of the downstream IAB node 16 and a time division multiplexed-transmission configuration indicator, TDM-TCI, configuration for beam management.

According to this aspect, in some embodiments, the network node 16, processing circuitry 68, and/or radio interface 62 are further configured to provide the downstream IAB node with space division multiplexed-TCI (SDM-TCI) configurations. In some embodiments, the SDM-TCI configurations are based at least in part on a hard/soft/not available (H/S/NA) configuration of the downstream IAB node 16.

According to another aspect, a method implemented in a network node 16 operating as an Internet Access and Backhaul (IAB) node includes: receiving an indication of a set of restricted IAB-data unit, IAB-DU, beams from a downstream IAB node 16 based at least in part on IAB-specific synchronization signal blocks, SSBs; and providing the downstream IAB node 16 with resource configurations for respective multiplexing modes of the downstream IAB node 16 and a time division multiplexed-transmission configuration indicator, TDM-TCI, configuration for beam management.

According to this aspect, in some embodiments, the method also includes providing the downstream IAB node 16 with space division multiplexed-TCI (SDM-TCI) configurations. In some embodiments, the SDM-TCI configurations are based at least in part on a hard/soft/not available (H/S/NA) configuration of the downstream IAB node 16.

### Some Other Examples

Example A1. A network node 16 operating as an Internet Access and Backhaul (IAB) node, the network node 16 configured to communicate with at least another IAB node 16, the network node 16 configured to, and/or comprising a radio interface 62 and/or comprising processing circuitry 68 configured to:
determine a set of restricted IAB-data unit, IAB-DU, beams of a child IAB node 16 based at least in part on IAB-specific synchronization signal blocks, SSBs; and
indicate the set of restricted IAB-DU beams to the child IAB node 16 using reference signal indices or transmission configuration indicator, TCI.
Example A2. The network node 16 of Example A1, wherein associations between reference signal indices and IAB-DU beams are based at least in part on earlier reference signal transmissions from the child IAB node 16.
Example A3. The network node 16 of any of Examples A1 and A2, wherein the indication of the set of restricted IAB-DU beams includes an indication of SSB indices.
Example A4. The network node 16 of any of Examples A1-A3, wherein the indication of the set of restricted IAB-DU beams includes an indication of TCI states.
Example A5. The network node 16 of any of Examples A1-A4, wherein the indication of the set of restricted IAB-DU includes a medium access control (MAC) control element (CE) message configured to indicate corresponding channel state information (CSI) resource indices (CRIs).
Example B1. A method in a network node 16 operating as an Internet Access and Backhaul (IAB) node, the network node 16 configured to communicate with at least another IAB node 16, the method comprising:
determining a set of restricted IAB-data unit, IAB-DU, beams of a child IAB node 16 based at least in part on IAB-specific synchronization signal blocks, SSBs; and
indicating the set of restricted IAB-DU beams to the child IAB node 16 using reference signal indices or transmission configuration indicator, TCI.
Example B2. The method of Example B1, wherein associations between reference signal indices and IAB-DU beams are based at least in part on earlier reference signal transmissions from the child IAB node 16.
Example B3. The method of any of Examples B1 and B2, wherein the indication of the set of restricted IAB-DU beams includes an indication of SSB indices.
Example B4. The method of any of Examples B1-B3, wherein the indication of the set of restricted IAB-DU beams includes an indication of TCI states.
Example B5. The method of any of Examples B1-B4, wherein the indication of the set of restricted IAB-DU includes a medium access control (MAC) control element (CE) message configured to indicate corresponding channel state information (CSI) resource indices (CRIs).
Example C1. A network node 16 operating as an Internet Access and Backhaul (IAB) node, the network node 16 configured to communicate with at least another IAB node 16, network node 16 configured to, and/or comprising a radio interface and/or processing circuitry 68 configured to:
receive an indication of a set of restricted IAB-data unit, IAB-DU, beams from a downstream IAB node 16 based at least in part on IAB-specific synchronization signal blocks, SSBs; and
provide the downstream IAB node 16 with resource configurations for respective multiplexing modes of the downstream IAB node 16 and a time division multiplexed-transmission configuration indicator, TDM-TCI, configuration for beam management.
Example C2. The network node 16 of C1, wherein the network node 16, processing circuitry 68, and/or radio interface 62 are further configured to provide the downstream IAB node 16 with space division multiplexed-TCI (SDM-TCI) configurations.
Example C3. The network node 16 of Example C2, wherein the SDM-TCI configurations are based at least in part on a hard/soft/not available (H/S/NA) configuration of the downstream IAB node 16.
Example D1. A method implemented in a network node 16 operating as an Internet Access and Backhaul (IAB) node, the method comprising:
receiving an indication of a set of restricted IAB-data unit, IAB-DU, beams from a downstream IAB node 16 based at least in part on IAB-specific synchronization signal blocks, SSBs; and
providing the downstream IAB node 16 with resource configurations for respective multiplexing modes of the downstream IAB node 16 and a time division multiplexed-transmission configuration indicator, TDM-TCI, configuration for beam management.
Example D2. The method of D1, further comprising providing the downstream IAB node 16 with space division multiplexed-TCI (SDM-TCI) configurations.
Example D3. The method of Example D2, wherein the SDM-TCI configurations are based at least in part on a hard/soft/not available (H/S/NA) configuration of the downstream IAB node 16.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An Internet Access and Backhaul, IAB, node configured to communicate with a child IAB node, the IAB node, comprising:
processing circuitry configured to:
determine at least one restricted beam for an IAB-distributed unit, IAB-DU, of a child IAB node, when operating in spatial division multiplexing, SDM; and
indicate the at least one restricted beam for configuring the child IAB node, the indication of the at least one restricted beam corresponding to a deactivation of a Transmission Configuration Indicator, TCI state, which would be available when operating in time division multiplexing, TDM.

2. The IAB node of claim 1, wherein the indication is communicated to the child IAB node.

3. The IAB node of claim 1, wherein the at least one restricted beam is configured to restrict selection to one of:
the at least one restricted beam;
another beam that is located within the at least one restricted beam; and
another beam that partially overlaps with the at least one restricted beam.

4. The IAB node of claim 1, wherein the indication of the at least one restricted beam is associated with at least one TCI state.

5. The IAB node of claim 1, wherein the indication is provided by signaling individually per carrier.

6. The IAB node of claim 1, wherein the at least one restricted beam corresponds to a plurality of restricted beams to be applied to one of: a single carrier, subset of a plurality of carriers and the plurality of carriers.

7. The IAB node of claim 1, wherein the at least one restricted beam is indicated by one of:
Medium Access Control-Control Element, MAC-CE signaling;
at least one SSB index in MAC-CE signaling; and
at least one Channel State Information-Reference Signal, CSI-RS, resource index in MAC-CE signaling.

8. The IAB node of claim 1, wherein the restriction of the at least one restricted beam is configured to be considered by the child IAB node operating in SDM operation mode; and
the restriction of the at least one restricted beam is configured to be disregarded by the child IAB node operating in TDM operation mode.

9. The IAB node of claim 1, wherein the indication is transmitted to a Donor IAB node.

10. The IAB node of claim 1, wherein the processing circuitry is further configured to activate one of a TDM operation mode and SDM operation mode at the child IAB node, the at least one restricted beam being associated with the SDM operation mode and not the TDM operation mode.

11. The IAB node of claim 1, wherein the at least one restricted beam corresponds to at least one downlink beam used for communication from the child IAB node to a first IAB node.

12. The IAB node of claim 1, wherein the at least one restricted beam allows the IAB-DU and IAB-Mobile Termination, IAB-MT, of the child IAB node to simultaneously use the same resources.

13. An Internet Access and Backhaul, IAB, node, comprising:
processing circuitry configured to:
transmit a plurality of synchronization signal blocks, SSBs;
receive an indication associated with at least one restricted beam for an IAB-distributed unit, IAB-DU, of the IAB node; and
determine at least one IAB-DU beam for downlink transmission based at least on the indication associated with the at least one restricted beam, the indication of the at least one restricted beam being associated with at least one Transmission Configuration Indicator, TCI, state.

14. The IAB node of claim 13, wherein the indication is an explicit indication of the at least one restricted beam received from a parent IAB node.

15. The IAB node of claim 13, wherein the processing circuitry is further configured to, based on the indication, avoid selecting one of:
the at least one restricted beam;
another beam that is located within the at least one restricted beam; and
another beam that partially overlaps with the at least one restricted beam.

16. The IAB node of claim 13, wherein the indication is provided by signaling individually per carrier.

17. The IAB node of claim 13, wherein the at least one restricted beam corresponds to a plurality of restricted beams to be applied to one of: a single carrier, subset of a plurality of carriers and the plurality of carriers.

18. The IAB node of claim 13, wherein the at least one restricted beam is indicated by one of:
Medium Access Control-Control Element, MAC-CE signaling;
at least one SSB index in MAC-CE signaling; and
at least one Channel State Information-Reference Signal, CSI-RS, resource index in MAC-CE signaling.

19. The IAB node of claim 13, wherein the processing circuitry is configured to:
consider the restriction of the at least one restricted beam based on the IAB node operating in Spatial Division Multiplexing, SDM, operation mode; and
disregard the restriction of the at least one restricted beam based on the IAB node operating in Time Division Multiplexing, TDM, operation mode.

20.-23. (canceled)

24. A method implemented by an Internet Access and Backhaul, IAB, node that is configured to communicate with a child IAB node, the method comprising:
determining at least one restricted beam for an IAB-distributed unit, IAB-DU, of a child IAB node when operating in spatial division multiplexing, SDM; and
indicating the at least one restricted beam for configuring the child IAB node, the indication of the at least one restricted beam corresponding to a deactivation of a Transmission Configuration Indicator, TCI state, which would be available when operating in time division multiplexing, TDM.

25.-46. (canceled)
